(19) United States
(12) Patent Application Publication
(10) Pub. No.: US 2024/0090548 A1
(43) Pub. Date: Mar. 21, 2024

(54) FLAVOR ALTERING AND/OR SWEETNESS ENHANCING COMPOSITIONS AND METHODS AND FOOD AND BEVERAGE PRODUCTS BASED THEREON

(71) Applicant: TATE & LYLE INGREDIENTS AMERICAS LLC, Hoffman Estates, IL (US)

(72) Inventors: Joshua Fletcher, Hoffman Estates, IL (US); John Bridges, Hoffman Estates, IL (US); James Carr, Hoffman Estates, IL (US); Kennet Carabante, Hoffman Estates, IL (US); Leslie Kleiner, Hoffman Estates, IL (US); Xiaoqing Want, Hoffman Estates, IL (US); Brian Albert, Hoffman Estates, IL (US)

(21) Appl. No.: 17/768,819

(22) PCT Filed: Oct. 14, 2020
(86) PCT No.: PCT/US2020/055553

§ 371 Date: Apr. 13, 2022

Related U.S. Application Data
(60) Provisional application No. 62/914,844, filed on Oct. 14, 2019.

(51) Int. Cl. A23L 27/00; A23C 9/13; A23L 2/56; A23L 2/60; A23L 27/30; A23L 33/21; A23L 33/26

(52) U.S. Cl. CPC A23L 27/88; A23C 9/1307; A23L 2/56; A23L 2/60; A23L 27/36; A23L 27/84; A23L 33/21; A23L 33/26

(57) ABSTRACT

The present disclosure provides flavor altering and/or sweetness enhancing compositions, methods, and food and beverage products using a soluble oligomeric component selected from soluble dietary fiber and polydextrose to alter flavor and/or enhance sweetness.

### CROSS-REFERENCE TO RELATED APPLICATIONS

This application claims the benefit of priority of U.S. Provisional Patent Application No. 62/914,844, filed Oct. 14, 2019, which is hereby incorporated herein by reference in its entirety.

### BACKGROUND OF THE DISCLOSURE

### 1. Field of the Disclosure

The present disclosure relates generally to food and beverage products. More particularly, the present disclosure relates to soluble dietary fiber and/or polydextrose-containing compositions having enhanced flavor and/or sweetness.

### 2. Technical Background

While high potency sweeteners are capable of replacing sugar in applications at high use levels they often suffer from off-tastes at higher use levels. Sweetness enhancers may be used to allow a sweetener to be used at high sweetness levels while avoiding levels associated with high off-tastes. Furthermore, the balance of flavor profile is important in food and beverages. High potency sweeteners may cause flavors to become out of balance in a product and being able to modulate these flavors is desirable.

As such, there is a need for compositions that can enhance sweetness of high-potency sweeteners and to provide other desirable effects on flavor profiles of food and beverage products.

### SUMMARY OF THE DISCLOSURE

One aspect of the disclosure is a sweetened food or beverage product that includes at least one sweetener; and at least 1 wt % of a soluble oligomeric component selected from soluble dietary fiber and polydextrose, or a combination thereof. Notably, the soluble oligomeric component is present in an amount that enhances the perceived sweetness of the sweetened food or beverage product by an amount that is greater than any sweetness due to the soluble oligomeric component itself.

Another aspect of the disclosure is a sweet taste-enhancing composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that enhances the perceived sweet taste of the food or beverage product by an amount that is greater than any sweet taste due to the soluble oligomeric component itself.

Another aspect of the disclosure is a sweetness-enhancing composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that enhances the perceived sweetness of the food or beverage product by an amount that is greater than any sweetness due to the soluble oligomeric component itself.

Another aspect of the disclosure is a flavor modifying composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that alters a flavor of the food or beverage product by an amount that is greater than any alteration due to a flavor of the soluble oligomeric component itself.

Another aspect of the disclosure is a flavor-enhancing composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that enhances a flavor of the food or beverage product by an amount that is greater than any enhancement due to a flavor of the soluble oligomeric component itself.

Another aspect of the disclosure is a method for enhancing the sweetness of a food or beverage product containing a sweetener, by including at least 1 wt % of soluble oligomeric component selected from soluble dietary fiber and polydextrose, or a combination thereof in the food or beverage product. The enhancement is by an amount that is greater than any sweetness due to the soluble oligomeric component itself.

Another aspect of the disclosure is a method of sweet taste enhancement, including: including in a food or beverage product containing at least one sweetener at least 1 wt % of soluble oligomeric component selected from soluble dietary fiber and polydextrose, or a combination thereof. The enhancement is by an amount that is greater than any sweet taste due to the soluble oligomeric component itself.

Another aspect of the disclosure is a method of flavor modification, the method including: including in a food or beverage product containing at least one sweetener at least 1 wt % of soluble oligomeric component selected from soluble dietary fiber and polydextrose, or a combination thereof. Notably, the soluble oligomeric component is included in an amount that alters (e.g., enhances, reduces, or changes the character of) a flavor of the food or beverage product by an amount that is greater than any alteration due to a flavor of the soluble oligomeric component itself.

Another aspect of the disclosure is a method of flavor enhancement, the method including: including in a food or beverage product containing at least one sweetener at least 1 wt % of soluble oligomeric component selected from soluble dietary fiber and polydextrose, or a combination thereof. Notably, the soluble oligomeric component is included in an amount that enhances a flavor of the food or beverage product by an amount that is greater than any alteration due to a flavor of the soluble oligomeric component itself.

Another aspect of the disclosure is a flavor-modifying composition that includes at least 1 wt % of a soluble oligomeric component selected from soluble dietary fiber and polydextrose, or a combination thereof, in a food or beverage product. Notably, the soluble oligomeric component is present in an amount that alters (e.g., enhances, reduces, or changes a character of) a perception of a flavor in the food or beverage product by an amount that is greater than any alteration due to a flavor of the soluble oligomeric component itself.

Another aspect of the disclosure is a flavor-enhancing composition that includes at least 1 wt % of a soluble oligomeric component selected from soluble dietary fiber and polydextrose, or a combination thereof, in a food or beverage product. Notably, the soluble oligomeric component is present in an amount that enhances a perception of the flavor in the food or beverage product by an amount that is greater than any alteration due to a flavor of the soluble oligomeric component itself.

Another aspect of the disclosure is a food or beverage product that includes at least 1 wt % of a soluble oligomeric component selected from soluble dietary fiber and polydextrose, or a combination thereof. Notably, the soluble oligomeric component is present in an amount that alters (e.g., enhances, reduces, or changes a character of) a perception of a flavor of the food or beverage product by an amount that is greater than any alteration due to a flavor of the soluble oligomeric component itself.

Another aspect of the disclosure is a method for flavor modification, the method including: including at least 1 wt % of soluble oligomeric component selected from soluble dietary fiber and polydextrose, or a combination thereof in a food or beverage product, wherein the soluble oligomeric component alters (e.g., enhances, reduces, or changes a character of) the perception of a flavor of the food or beverage product by an amount that is greater than any alteration due to a flavor of the soluble oligomeric component itself.

Another aspect of the disclosure is a method for flavor enhancement, the method comprising including at least 1 wt % of soluble oligomeric component selected from soluble dietary fiber and polydextrose, or a combination thereof in a food or beverage product, wherein the soluble oligomeric component enhances the perception of a flavor in the food or beverage product by an amount that is greater than any enhancement due to a flavor of the soluble oligomeric component itself.

And another aspect of the disclosure is a method for altering (e.g., enhancing, reducing, or changing a character of) the perception of a flavor of a food or beverage product, the method comprising including at least 1 wt % of soluble oligomeric component selected from soluble dietary fiber and polydextrose, or a combination thereof in the food or beverage product, wherein the soluble oligomeric component alters (e.g., enhances, reduces, or changes a character of) the perception of a flavor of the food or beverage product by an amount that is greater than any alteration due to a flavor of the soluble oligomeric component itself.

Additional aspects of the disclosure will be evident from the disclosure herein.

### BRIEF DESCRIPTION OF THE DRAWINGS

FIGS. 1-3 are graphs summarizing the sweetness data of Example 1.

FIGS. 4 and 5 are graphs summarizing the overall acceptance data of Example 1.

FIGS. 6 and 7 are graphs summarizing the sucrose-like quality data of Example 1.

FIGS. 8 and 9 are graphs summarizing the off-taste data of Example 1.

FIGS. 10 and 10A are graphs summarizing the impact of soluble dietary fiber on sweetness, off-taste and overall liking in the experiments of Example 2.

FIG. 11 is a graph comparing the impact of soluble dietary fiber on perceived thickness as compared to sugar and high fructose dietary syrup in the experiments of Example 2.

FIG. 12 presents the impact of soluble dietary fiber on liking as a function of sweetness in the experiments of Example 2.

FIGS. 13 and 14 are charts illustrate the physical and oral attributes determined in Example 3.

FIGS. 15-17 present initial sweetness data for an example stevia sweetener A, an example stevia sweetener B, and an example stevia sweetener C, respectively in the experiments of Example 4.

FIGS. 18-20 present maximum sweetness data for an example stevia sweetener A, an example stevia sweetener B, and an example stevia sweetener C, respectively in the experiments of Example 4.

### DETAILED DESCRIPTION

In various studies of soluble dietary fibers and polydextrose in combination with sweeteners, the present inventors determined that certain combinations provided an unexpected sweetness effect: the use of soluble dietary fiber or polydextrose can provide an enhanced sweetness to the sweetened compositions, well in excess of any sweetness provided by the soluble dietary fiber or polydextrose itself. For example, a soluble dietary fiber at 5 wt % was tested with varying concentrations of rebaudioside A and a rebaudioside A-rebaudioside B blend. Unexpectedly, the stevia/soluble dietary fiber combination provided about 2 SEV (sucrose equivalent value) more sweetness than products without the soluble dietary fiber. In this test fiber did not impact the off-flavor or overall liking scores given to the products by the tasting panel. In another study, a soluble dietary fiber at 2 wt % and 5 wt % enhanced the sweetness of compositions sweetened with a rebaudioside A-rebaudioside B blend in a dose-dependent manner. Additionally, it was noted that soluble dietary fibers and polydextrose were unexpectedly able to modify the overall flavor profile of certain flavored systems. Accordingly, the present inventors discovered that certain soluble oligomeric components as described herein can provide enhancement of sweetness of stevia-sweetened systems and modification of flavors in flavored systems.

Accordingly, one aspect of the disclosure is a sweetened food or beverage product that includes at least one sweetener; and at least 1 wt % of a soluble oligomeric component selected from soluble dietary fiber and polydextrose, or a combination thereof. Notably, the soluble oligomeric component is present in an amount that enhances the perceived sweetness of the sweetened food or beverage product by an amount that is greater than any sweetness due to the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a sweet taste-enhancing composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that enhances the perceived sweet taste of the food or beverage product by an amount that is greater than any sweet taste due to the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a sweetness-enhancing composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that enhances the perceived sweetness of the food or beverage product by an amount that is greater than any sweetness due to the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a flavor modifying composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that alters a flavor of the food or beverage product by an amount that is greater than any alteration due to a flavor of the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

As used herein, an alteration of flavor can be any perception in the alteration of a flavor in the food or beverage. This can be, for example, an enhancement of the perception of the flavor or a reduction of the perception of the flavor. An alteration can also be a change in the character of the flavor as perceived by a taster.

Notably, flavors are understood to be imparted to food substantially through non-taste mechanisms, typically substantially through olfaction. Flavors can be provided to a food or beverage product by a flavoring added for the purpose of providing flavor, and/or can be provided by an ingredient of the food or beverage product. Accordingly, in various embodiments, a flavor that is altered through use of a soluble oligomeric component as described herein is not saltiness, sweetness, sourness, bitterness, or umami.

Another aspect of the disclosure is a flavor-enhancing composition that includes at least one sweetener; and at least 1 wt % of a soluble oligomeric component selected from soluble dietary fiber and polydextrose, or a combination thereof, in a food or beverage product. Notably, the soluble oligomeric component is present in an amount that enhances a flavor of the food or beverage product by an amount that is greater than any enhancement due to a flavor of the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a method for enhancing the sweetness of a food or beverage product containing a sweetener, by including at least 1 wt % of soluble oligomeric component selected from soluble dietary fiber and polydextrose, or a combination thereof in the food or beverage product. The enhancement is by an amount that is greater than any sweetness due to the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a method of sweet taste enhancement, including: including in a food or beverage product containing at least one sweetener at least 1 wt % of soluble oligomeric component selected from soluble dietary fiber and polydextrose, or a combination thereof. The enhancement is by an amount that is greater than any sweet taste due to the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a method of flavor modification, the method including: including in a food or beverage product containing at least one sweetener at least 1 wt % of soluble oligomeric component selected from soluble dietary fiber and polydextrose, or a combination thereof. Notably, the soluble oligomeric component is included in an amount that alters (e.g., enhances, reduces, or changes the character of) a flavor of the food or beverage product by an amount that is greater than any alteration due to a flavor of the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a method of flavor enhancement, the method including: including in a food or beverage product containing at least one sweetener at least 1 wt % of soluble oligomeric component selected from soluble dietary fiber and polydextrose, or a combination thereof. Notably, the soluble oligomeric component is included in an amount that enhances a flavor of the food or beverage product by an amount that is greater than any alteration due to a flavor of the soluble oligomeric component itself. A variety of sweeteners can be used as the sweetener as described throughout the disclosure. However, in certain embodiments as otherwise described herein, the at least one sweetener is a steviol glycoside, e.g., present in a total amount of at least 30 ppm, or at least 100 ppm.

Another aspect of the disclosure is a flavor-modifying composition that includes at least 1 wt % of a soluble oligomeric component selected from soluble dietary fiber and polydextrose, or a combination thereof, in a food or beverage product. Notably, the soluble oligomeric component is present in an amount that alters (e.g., enhances, reduces, or changes a character of) a perception of a flavor in the food or beverage product by an amount that is greater than any alteration due to a flavor of the soluble oligomeric component itself. In certain such embodiments, the food or beverage product includes a sweetener, e.g., as otherwise described herein.

Another aspect of the disclosure is a flavor-enhancing composition that includes at least 1 wt % of a soluble oligomeric component selected from soluble dietary fiber and polydextrose, or a combination thereof, in a food or beverage product. Notably, the soluble oligomeric component is present in an amount that enhances a perception of the flavor in the food or beverage product by an amount that is greater than any alteration due to a flavor of the soluble oligomeric component itself. In certain embodiments, the food or beverage product includes a sweetener, e.g., as otherwise described herein.

Another aspect of the disclosure is a food or beverage product that includes at least 1 wt % of a soluble oligomeric component selected from soluble dietary fiber and polydextrose, or a combination thereof. Notably, the soluble oligomeric component is present in an amount that alters (e.g., enhances, reduces, or changes a character of) a perception of a flavor of the food or beverage product by an amount that is greater than any alteration due to a flavor of the soluble oligomeric component itself. In certain such embodiments, the food or beverage product includes a sweetener, e.g., as otherwise described herein.

Another aspect of the disclosure is a method for flavor modification, the method including: including at least 1 wt % of soluble oligomeric component selected from soluble dietary fiber and polydextrose, or a combination thereof in a food or beverage product, wherein the soluble oligomeric component alters (e.g., enhances, reduces, or changes a character of) the perception of a flavor of the food or beverage product by an amount that is greater than any alteration due to a flavor of the soluble oligomeric component itself. In certain such embodiments, the food or beverage product includes a sweetener, e.g., as otherwise described herein.

Another aspect of the disclosure is a method for flavor enhancement, the method comprising including at least 1 wt % of soluble oligomeric component selected from soluble dietary fiber and polydextrose, or a combination thereof in a food or beverage product, wherein the soluble oligomeric component enhances the perception of a flavor in the food or beverage product by an amount that is greater than any enhancement due to a flavor of the soluble oligomeric component itself. In certain such embodiments, the food or beverage product includes a sweetener, e.g., as otherwise described herein.

And another aspect of the disclosure is a method for altering (e.g., enhancing, reducing, or changing a character of) the perception of a flavor of a food or beverage product, the method comprising including at least 1 wt % of soluble oligomeric component selected from soluble dietary fiber and polydextrose, or a combination thereof in the food or beverage product, wherein the soluble oligomeric component alters (e.g., enhances, reduces, or changes a character of) the perception of a flavor of the food or beverage product by an amount that is greater than any alteration due to a flavor of the soluble oligomeric component itself.

Sweetnesses are determined by a trained panel of tasters, comparing to control formulations having sucrose. In many contexts, sweetness is quantified by “sucrose equivalent value” or “SEV.” which as used herein refers to the sweetness equivalent of a sweetener related to the sweetness of sucrose on a weight percent basis. For example, a food or beverage product having an SEV value of 5 would have a sweetness similar to an otherwise identical food or beverage product having 5% by weight sucrose (i.e., instead of the stevia sweetener and the soluble oligomeric component).

As the person of ordinary skill in the art will appreciate, some soluble oligomeric components can themselves have some sweetness. For example, certain soluble dietary fibers themselves are at least somewhat sweet, and thus can themselves add sweetness to a composition. In such cases, the enhancement is more than additive (i.e., more than the sum of the SEV of the food or beverage product with the at least one sweetener and the SEV of the food or beverage product with the soluble oligomeric component). But in certain embodiments, the soluble oligomeric component itself does not provide substantial sweetness to the food or beverage product (for example, is present in an amount less than an amount of the soluble oligomeric component that provides 1.5 SEV to the food or beverage product in the absence of the at least one sweetener, e.g., no more than ⅔ of that amount, or no more than ⅓ of that amount, or no more than 1/10 of that amount, or no more than 1/15 of that amount).

The methods and food and beverage products described herein can provide a variety of degrees of sweetness enhancement, as shown in the Examples below. For example, in certain embodiments as otherwise described herein, the enhancement in sweetness is at least 0.5 SEV, e.g., in the range of 0.5-3 SEV or 0.5-2.5 SEV. In certain embodiments as otherwise described herein, the enhancement in sweetness is at least 1 SEV, e.g., in the range of 1-3.5 SEV or 1-3 SEV. In certain embodiments as otherwise described herein, the enhancement in sweetness is at least 1.5 SEV, e.g., in the range of 1.5-3.5 SEV, or 1.5-3 SEV.

As described in more detail below, the present inventors have noted that such enhancements in sweetness can be used to provide sweetness to a food or beverage product even when a sweetener is present only in a subthreshold amount. That is, the enhancement can provide a food or beverage product that is perceived as sweet by a consumer, even though there is less than a subthreshold amount of sweetener therein in combination with a soluble oligomeric component as described herein.

As the person of ordinary skill in the art will appreciate, sweetness can be perceived rapidly or more slowly. As used herein, an initial sweetness is a maximum sweetness level achieved in the first second after tasting. In contrast, a maximum sweetness is the maximum sweetness level perceived after tasting a sample: this may be during the first second after tasting, or somewhat later. In certain embodiments as otherwise described herein, the perceived sweetness (i.e., that is enhanced by the presence of the soluble oligomeric component) is an initial sweetness. In certain embodiments as otherwise described herein, the perceived sweetness is a maximum sweetness.

Moreover, the present inventors have determined that the use of a soluble oligomeric component as described herein can enhance the sweet taste of a food or beverage. As used herein, a “sweet taste” relates to the quality of the sweetness, e.g., its sucrose-like properties or any off-tastes related to the sweetness (such as bitterness), as opposed to the intensity of the sweetness itself. Like sweetness, enhancement of sweet taste can be determined by a trained tasting panel.

As noted above, a variety of sweeteners can be used in various aspects of the methods, compositions and food and beverage products described herein. In certain embodiments as otherwise described herein, the at least one sweetener is at least one steviol glycoside (e.g., one or more of stevioside and Rebaudiosides A-F, J, I, M, N, and O such as rebaudioside A, rebaudioside B and/or rebaudioside M (also known as Rebaudioside X)). As is known in the art, steviol glycosides can be provided by stevia sweeteners, which can include, e.g., a single steviol glycoside substantially alone, or a combination of steviol glycosides. For example, in certain embodiments as otherwise described herein, the at least one steviol glycoside is Rebaudioside A. In other embodiments as otherwise described herein, the at least one steviol glycoside is Rebaudioside M (also known as Rebaudioside X). In certain embodiments as otherwise described herein, the at least one steviol glycoside is a combination of Rebaudioside A and Rebaudioside B. In other embodiments as otherwise described herein, the at least one steviol glycoside is a combination of stevioside with one or more of Rebaudioside A, Rebaudioside B and Rebaudioside D.

As used herein, the term “steviol glycoside” refers to a glycoside of steviol, including, but not limited to, naturally occurring steviol glycosides, e.g., steviolmonoside, steviolmonoside A, steviolbioside, steviolbioside A, steviolbioside B, rubusoside, stevioside, stevioside A (rebaudioside KA), stevioside B, stevioside C, rebaudiosides A-F, J, I, M, N, and O such as rebaudioside A, rebaudioside B, rebaudioside C, rebaudioside D, rebaudioside E, rebaudioside E2, rebaudioside E3, rebaudioside AM, rebaudioside J, rebaudioside, I, rebaudioside M (also known as rebaudioside X), rebaudioside N, rebaudioside O, and synthetic steviol glycosides, e.g., enzymatically glucosylated steviol glycosides and combinations thereof.

The at least one steviol glycoside can be provided in the food or beverage product in a variety of amounts, to provide a desired sweetness. Notably, combination with a soluble oligomeric component as described herein can provide higher perceived sweetness for a given amount of steviol glycoside(s), or can provide an equivalent perceived sweetness for a lesser amount of steviol glycoside(s). In certain embodiments as otherwise described herein, the at least one steviol glycoside is present in the food or beverage product in an amount of at least 30 ppm, e.g., at least 100 ppm. In certain embodiments as otherwise described herein, the at least one steviol glycoside is present in the food or beverage product in an amount of at least 200 ppm, e.g., at least 400 ppm or at least 600 ppm. In certain embodiments as otherwise described herein, the at least one steviol glycoside is present in the food or beverage product in an amount (i.e., total of all the steviol glycosides) in the range of 100-3000 ppm, e.g., 200-3000 ppm, 400-3000 ppm, or 600-3000 ppm. In certain embodiments as otherwise described herein, the at least one steviol glycoside is present in the food or beverage product in an amount in the range of 100-2000 ppm, e.g., 200-2000 ppm, 400-2000 ppm, or 600-2000 ppm. In certain embodiments as otherwise described herein, the at least one steviol glycoside is present in the food or beverage product in an amount in the range of 100-1500 ppm, e.g., 200-1500 ppm, 400-1500 ppm, or 600-1500 ppm. In certain embodiments as otherwise described herein, the at least one steviol glycoside is present in the food or beverage product in an amount in the range of 100-1000 ppm, e.g., 200-1000 ppm, 400-1000 ppm, or 600-1000 ppm.

A variety of steviol glycoside-containing sweeteners can be useful in providing the at least one steviol glycoside to the food or beverage product. The sweeteners described in the Examples can be useful to provide steviol glycosides.

As described above, the present inventors have noted that the sweetness enhancement described herein can provide for a perception of sweetness even when a subthreshold amount of sweetener is used. As the perception of sweetness of a sweetener is different in different food or beverage products, it can be useful to quantify the amount of sweetener by its sweetness contribution in a particular food or beverage product. In certain embodiments, the at least one steviol glycoside is present in the food or beverage product in an amount less than an amount of the at least one steviol glycoside that provides 1.5 SEV to the food or beverage product (i.e., in the absence of the soluble oligomeric component). For example, in certain embodiments, the at least one steviol glycoside is present in the food or beverage product in an amount that is no more than ⅔ of the amount that provides 1.5 SEV to the food or beverage product, or even in an amount that is no more than ⅓ of the amount that provides 1.5 SEV to the food or beverage product. And in certain embodiments, the at least one high-intensity sweetener is present in the food or beverage in an amount such that it does not provide perceptible sweetness to the food or beverage product (i.e., in the absence of the soluble oligomeric component). In certain such embodiments, the sweetness enhancement is such that the steviol glycoside and the soluble oligomeric component together provide at least 1.5 SEV to the food or beverage product, e.g., at least 2.0 SEV, at least 2.5 SEV, or even at least 3.0 SEV. This can result in the provision of perceptible sweetness to the food or beverage product. And the sweetness enhancement can be present even when the soluble oligomeric component itself does not provide detectable sweetness (for example, is present in an amount less than an amount of the soluble oligomeric component that provides 1.5 SEV to the food or beverage product in the absence of the steviol glycoside, e.g., no more than ⅔ of amount, or no more than ⅓ of that amount, or no more than 1/10 of that amount, or no more than 1/15 of that amount). Accordingly, the present inventors have noted that the combination of steviol glycoside in an amount that provides imperceptible sweetness, and a soluble oligomeric component in an amount that provides imperceptible sweetness can synergistically provide a food or beverage product with perceptible sweetness.

In certain embodiments as otherwise described herein, the at least one steviol glycoside (optionally with one or more additional non-sugar sweeteners) can be used as sugar replacements in food and beverage products as described herein. Thus, in certain embodiments as otherwise described herein, the food or beverage product does not include a sweetening sugar or sugar alcohol selected from sucrose, fructose, dextrose, lactose, xylose, mannitol, xylitol, maltitol, isomalt, lactitol and erythritol in an amount that provides more than 1 SEV, e.g., more than 0.5 SEV, or more than 0.2 SEV, to the food or beverage product. Similarly, in certain embodiments as otherwise described herein, the food or beverage product includes no more than 5 wt % of the sweetening sugar or sugar alcohol, e.g., no more than 2 wt % or no more than 1 wt %.

Of course, in other embodiments, the at least one steviol glycoside can be used in conjunction with sweetening sugars to provide increased sweetness for the amount of sweetening sugar. Thus, in certain embodiments as otherwise described herein, the food or beverage product includes in the range of 1-6 wt % sugar or sugar alcohol selected from sucrose, fructose, dextrose, lactose, xylose, mannitol, xylitol, maltitol, isomalt, lactitol and erythritol, e.g., 2-6 wt %.

While in certain embodiments as described above the at least one sweetener is a steviol glycoside, in other embodiments, the at least one sweetener is a different sweetener. In certain embodiments as otherwise described herein, the at least one sweetener is at least one high-intensity sweetener. Suitable high-intensity sweeteners include, for example, acesulfame K, alitame, aspartame, a glucosylated steviol glycoside, N—[N-[3-(3-hydroxy-4-methoxyphenyl)propyl]-L-α-aspartyl]-L-phenylalanine 1-methyl ester, N—[N-[3-(3-hydroxy-4-methoxyphenyl)-3-methylbutyl]-L-α-aspartyl]-L-phenylalanine 1-methyl ester, N—[N-[3-(3-methoxy-4-hydroxyphenyl)propyl]-L-α-aspartyl]-L-phenylalanine 1-methyl ester, neohesperidin dihydrochalcone, neotame, sucralose and salts and/or solvates thereof.

As described above, the present inventors have noted that the sweetness enhancement described herein can provide for a perception of sweetness even when a subthreshold amount of sweetener is used. In certain embodiments, the at least one high-intensity sweetener is present in the food or beverage product in an amount less than an amount of the at least one high-intensity sweetener that provides 1.5 SEV to the food or beverage product (i.e., in the absence of the soluble oligomeric component). For example, in certain embodiments, the at least one high-intensity sweetener is present in the food or beverage product in an amount that is no more than ⅔ of, e.g., no more than ⅓) of the amount that provides 1.5 SEV to the food or beverage product. And in certain embodiments, the at least one high-intensity sweetener is present in the food or beverage in an amount such that it does not provide perceptible sweetness to the food or beverage product (i.e., in the absence of the soluble oligomeric component). In certain such embodiments, the sweetness enhancement is such that the high-intensity sweetener and the soluble oligomeric component together provide at least 1.5 SEV to the food or beverage product, e.g., at least 2.0 SEV, at least 2.5 SEV, or even at least 3.0 SEV. This can result in the provision of perceptible sweetness to the food or beverage product. And the sweetness enhancement can be present even when the soluble oligomeric component itself does not provide detectable sweetness (for example, is present in an amount less than an amount of the soluble oligomeric component that provides 1.5 SEV to the food or beverage product in the absence of the high-intensity sweetener, e.g., no more than ⅔ of that amount, or no more than ⅓ of that amount, or no more than 1/10 of that amount, or no more than 1/15 of that amount). Accordingly, the present inventors have noted that the combination of high-intensity sweetener in an amount that provides imperceptible sweetness, and a soluble oligomeric component in an amount that provides imperceptible sweetness can synergistically provide a food or beverage product with perceptible sweetness.

In certain embodiments, the at least one sweetener is a natural high-intensity sweetener, i.e., a high-intensity sweetener obtained from a natural source. For example, a natural high-intensity sweetener may be used in its raw form (e.g. as a plant) or may be extracted or purified from the natural source. Examples of suitable natural high-intensity sweeteners include abrusoside A, baiyunoside, brazzein, curculin, cyclocarioside 1, glycyphyllin, glycyrrhizic acid, hernandulcin, a monk fruit extract, mabinlin, monatin, monellin, mukurozioside, osladin, periandrins, phlomisosides, phloridzin, phyllodulcin, polypodoside A, pterocaryoside A, pterocaryoside B, rubusoside, thaumatin and trilobatin, and salts and/or solvates thereof.

As described above, the present inventors have noted that the sweetness enhancement described herein can provide for a perception of sweetness even when a subthreshold amount of sweetener is used. In certain embodiments, the at least one natural high-intensity sweetener is present in the food or beverage product in an amount less than an amount of the at least one natural high-intensity sweetener that provides 1.5 SEV to the food or beverage product (i.e., in the absence of the soluble oligomeric component). For example, in certain embodiments, the at least one natural high-intensity sweetener is present in the food or beverage product in an amount that is no more than ⅔ of, e.g., no more than ⅓) of the amount that provides 1.5 SEV to the food or beverage product. And in certain embodiments, the at least one natural high-intensity sweetener is present in the food or beverage in an amount such that it does not provide perceptible sweetness to the food or beverage product (i.e., in the absence of the soluble oligomeric component).” In certain such embodiments, the sweetness enhancement is such that the natural high-intensity sweetener and the soluble oligomeric component together provide at least 1.5 SEV to the food or beverage product, e.g., at least 2.0 SEV, at least 2.5 SEV, or even at least 3.0 SEV. This can result in the provision of perceptible sweetness to the food or beverage product. And the sweetness enhancement can be present even when the soluble oligomeric component itself does not provide detectable sweetness (for example, is present in an amount less than an amount of the soluble oligomeric component that provides 1.5 SEV to the food or beverage product in the absence of the natural high-intensity sweetener, e.g., no more than ⅔ of that amount, or no more than ⅓ of that amount, or no more than 1/10 of that amount, or no more than 1/15 of that amount). Accordingly, the present inventors have noted that the combination of natural high-intensity sweetener in an amount that provides imperceptible sweetness, and a soluble oligomeric component in an amount that provides imperceptible sweetness can synergistically provide a food or beverage product with perceptible sweetness.

The at least one sweetener may include a bulk sweetener. Suitable bulk sweeteners include allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose, invert sugar, arabitol, glycerol, hydrogenated starch hydrolysate (e.g., maltitol syrup, sorbitol syrup), isomalt, lactitol, maltitol, mannitol, sorbitol and xylitol; allulose (also known as D-psicose), glucose, erythritol, fructose, and sucrose. These may be provided alone or in combination, e.g., as by glucose-fructose syrup, or high-fructose corn syrup.

As described above, the present inventors have noted that the sweetness enhancement described herein can provide for a perception of sweetness even when a subthreshold amount of sweetener is used. In certain embodiments, the at least one bulk sweetener is present in the food or beverage product in an amount less than an amount of the at least one bulk sweetener that provides 1.5 SEV to the food or beverage product (i.e., in the absence of the soluble oligomeric component). For example, in certain embodiments, the at least one bulk sweetener is present in the food or beverage product in an amount that is no more than ⅔ of, e.g., no more than ⅓) of the amount that provides 1.5 SEV to the food or beverage product. And in certain embodiments, the at least one bulk sweetener is present in the food or beverage in an amount such that it does not provide perceptible sweetness to the food or beverage product (i.e., in the absence of the soluble oligomeric component). In certain such embodiments, the sweetness enhancement is such that the bulk sweetener and the soluble oligomeric component together provide at least 1.5 SEV to the food or beverage product, e.g., at least 2.0 SEV, at least 2.5 SEV, or even at least 3.0 SEV. This can result in the provision of perceptible sweetness to the food or beverage product. And the sweetness enhancement can be present even when the soluble oligomeric component itself does not provide detectable sweetness (for example, is present in an amount less than an amount of the soluble oligomeric component that provides 1.5 SEV to the food or beverage product in the absence of the bulk sweetener, e.g., no more than ⅔ of that amount, or no more than ⅓ of that amount, or no more than 1/10 of that amount, or no more than 1/15 of that amount). Accordingly, the present inventors have noted that the combination of bulk sweetener in an amount that provides imperceptible sweetness, and a soluble oligomeric component in an amount that provides imperceptible sweetness can synergistically provide a food or beverage product with perceptible sweetness.

The at least one sweetener in the food or beverage product, be it a steviol glycoside, a high-intensity sweetener, a bulk sweetener, or a combination thereof, can be provided together with the soluble dietary fiber to provide a variety of SEV values to the food or beverage product. For example, in various embodiments as otherwise described herein, the food or beverage product has a sweetness in the range of 1-20 SEV. For example, in various embodiments as otherwise described herein the food or beverage product has a sweetness in the range of 1-15 SEV, or 1-12 SEV, or 1-10 SEV, or 1-8 SEV, or 1-5 SEV, or 2-20 SEV, or 2-15 SEV, or 2-12 SEV, or 2-10 SEV, or 2-8 SEV, or 5-20 SEV, or 5-15 SEV, or 5-12 SEV, or 5-10 SEV, or 8-20 SEV, or 8-15 SEV, or 8-12 SEV, or 10-20 SEV, or 10-15 SEV, or 15-20 SEV.

Notably, as described in the Examples below, the present inventors have determined not only that soluble dietary fiber and polydextrose can enhance sweetness of sweetened food and beverage products, but also that they can unexpectedly modify flavors in food and beverage products.

Such flavor modification can be in foods and beverages including rebaudiosides as described above, or in foods and beverages that are otherwise sweetened as described above, or even in foods and beverages that are unsweetened. For example, the food or beverage product can include one or more sweeteners in an amount sufficient that the food or beverage has an SEV value in the range of 1-20 (or any other range as described above). A variety of sweeteners can be used, e.g., bulk sweeteners such as sucrose, fructose, dextrose, xylose and allulose, and other sweeteners such as steviol glycosides, mogrosides, aspartame, sucralose, saccharin, neotame acesulfame K and cyclamate.

In certain embodiments as otherwise described herein, the alteration of the perception of a flavor of the food or beverage product is an enhancement of the perception. For example, in certain such embodiments, the flavor is provided by a flavoring, and the enhancement provides a perception that is equivalent to a perception of the flavoring in a food or beverage product lacking the soluble oligomeric component and including at least 120% of the amount of the flavoring, e.g., at least 150% of the amount of flavoring.

In certain embodiments as otherwise described herein, the alteration of the perception of a flavor of the food or beverage product is a reduction of the perception. For example, in certain such embodiments, the flavor is provided by a flavoring, and the reduction provides a perception that is equivalent to a perception of the flavoring in a food or beverage product lacking the soluble oligomeric component and including no more than 83% of the amount of the flavoring, e.g., no more than 67% of the amount of flavoring.

And in certain embodiments as otherwise described herein, the soluble oligomeric component enhances a perception of a first flavor in the food or beverage product, and decreases a perception of a second flavor in the food or beverage product. Thus, the overall flavor of a food or beverage can be significantly modified by the use of soluble oligomeric components as described herein.

For example, in certain embodiments as otherwise described herein, the flavoring is D-limonene, and the perception altered by the soluble oligomeric component is one or more of sweet, sour, lemon, peel, citrus, and astringency.

In certain embodiments as otherwise described herein, the flavoring is benzaldehyde, and the perception altered by the soluble oligomeric component is one or more of sour, sweetness, citrus, chemical off-flavor, bitter linger, corn-syrup off-note, and cardboard off-note.

In certain embodiments as otherwise described herein, the flavoring is ethyl butyrate, and the perception altered by the soluble oligomeric component is one or more of sweetness, sour, floral, grape level and grape flavor description.

Of course, a variety of other flavorings can be modified by the use of the soluble oligomeric components as described herein. While regulations on the use of flavors in food vary by country the Flavor and Extract Manufacturers Association (FEMA) of the United States maintains a list of such flavorings. For example, in various embodiments as otherwise described herein, a variety of natural, artificial and synthetic flavorings may be used, in any number and combination. For example, suitable flavorings may include synthetic flavor oils and flavoring aromatics and/or oils, oleoresins and extracts derived from plants, leaves, flowers and fruits. Examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Fruit flavorings may be useful in various embodiments as otherwise described herein, e.g., vanilla, and citrus oils including lemon, orange, lime, grapefruit, yuzu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, and papaya. Dairy-based flavorings such as milk flavor, butter flavor, cheese flavor, cream flavor, and yogurt flavor may also be useful. Beverage-type flavorings include tea or coffee flavors, such as green tea flavor, a oolong tea flavor, a tea flavor, and a coffee flavor. Chocolate and cocoa flavorings may also be useful, as can mint flavorings, such as peppermint flavor, spearmint flavor, and Japanese mint flavor; herb and spice flavorings, such as asafetida flavor, ajowan flavor, anise flavor, angelica flavor, fennel flavor, allspice flavor, cinnamon flavor, chamomile flavor, mustard flavor, cardamom flavor, caraway flavor, cumin flavor, clove flavor, pepper flavor, coriander flavor, sassafras flavor, savory flavor, Zanthoxyli Fructus flavor, perilla flavor, juniper berry flavor, ginger flavor, star anise flavor, horseradish flavor, thyme flavor, tarragon flavor, dill flavor, capsicum flavor, nutmeg flavor, basil flavor, marjoram flavor, rosemary flavor, bayleaf flavor, and wasabi (Japanese horseradish) flavor: alcoholic beverage-type flavorings, such as wine flavor, whisky flavor, brandy flavor, rum flavor, gin flavor, and liqueur flavor; floral flavorings; and vegetable flavorings, such as onion flavor, garlic flavor, cabbage flavor, carrot flavor, celery flavor, mushroom flavor, and tomato flavor.

Other useful flavorings include aldehydes and esters such as cinnamyl acetate, cinnamaldehyde, citral diethylacetal, dihydrocarvyl acetate, eugenyl formate, p-methylamisol. Generally any flavoring such as those described in Chemicals Used in Food Processing, publication 1274, pages 63-258, by the National Academy of Sciences, and in Arctander Perfume and Flavor Chemicals (Aroma chemicals) may be used in various embodiments of the disclosure.

Further examples of aldehyde flavorings suitable for use in various embodiments of the disclosure as otherwise described herein include but are not limited to acetaldehyde (apple), benzaldehyde (cherry, almond), ethyl butyrate (grape), anisic aldehyde (licorice, anise), cinnamic aldehyde (cinnamon), citral, i.e., alpha-citral (lemon, lime), neral, i.e., beta-citral (lemon, lime), D-limonene, decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

As described above with respect to the cases of D-limonene, benzaldehyde and ethyl butyrate, a variety of perceptions of flavorings may be modified by the soluble oligomeric components as described herein. However, in certain embodiments as otherwise described herein, a perception is other than sweetness or similarity to sugar is altered by the soluble oligomeric component.

The soluble oligomeric component can be present in the food or beverage product in a variety of amounts. Generally, there will be sufficient soluble oligomeric component in the food or beverage product to provide enhanced sweetness or altered perception of flavoring. The present inventors have found that the amount of sweetness enhancement increases with increasing amounts of soluble oligomeric component. Accordingly, in certain embodiments as otherwise described herein, the soluble oligomeric component is present in the food or beverage product in an amount of at least 2 wt %, e.g., at least 3 wt %. The data described herein show especially increased enhancement at 5 wt %; accordingly, in certain embodiments as otherwise described herein, the soluble oligomeric component is present in the food or beverage product in an amount of at least 5 wt %, e.g., or at least 7 wt %.

For example, in certain embodiments as otherwise described herein, the soluble oligomeric component is present in the food or beverage product in an amount in the range of 1-15 wt %, e.g., 1-12 wt %, or 1-10 wt % or 1-8 wt %. In certain embodiments as otherwise described herein, the soluble oligomeric component is present in the food or beverage product in an amount in the range of 2-15 wt %, e.g., 2-12 wt %, or 2-10 wt %, or 2-8 wt %. In certain embodiments as otherwise described herein, the soluble oligomeric component is present in the food or beverage product in an amount in the range of 3-15 wt %, e.g., 3-12 wt %, or 3-10 wt %, or 3-8 wt %. In certain embodiments as otherwise described herein, the soluble oligomeric component is present in the food or beverage product in an amount in the range of 5-15 wt %, e.g., 5-12 wt %, or 5-10 wt %, or 5-8 wt %. In certain embodiments as otherwise described herein, the soluble oligomeric component is present in the food or beverage product in an amount in the range of 7-15 wt %, e.g., 7-12 wt %, or 7-10 wt %.

In certain embodiments as otherwise described herein, the soluble dietary component is a soluble dietary fiber. As used herein, a soluble dietary fiber is a composition that is formed chiefly of dextrose oligomers (i.e., oligosaccharide content having at least 98% dextrose monomeric residues, and degree of polymerization in the range of 2-30) optionally together with dextrose (i.e., monosaccharide). As used herein, the total amount of dextrose oligomers and dextrose in a soluble dietary fiber is at least 95%, desirably at least 98%. The total amount of oligomeric sugar alcohol residues in the soluble dietary fiber is no more than 2%, e.g., no more than 1% or even no more than 0.5%. Thus, the soluble dietary fiber is not a “polydextrose” as the term is commonly understood.

Soluble dietary fibers can have a variety of molecular weights (consistent with remaining substantially water-soluble). As used herein, in many end uses, a relative viscosity is desired, and so it can be desirable for a soluble dietary fiber to have a relatively low molecular weight. In certain embodiments as otherwise described herein, the fiber has a weight average molecular weight in the range of 1000 g/mol to 2500 g/mol. For example, in certain such embodiments, the soluble dietary fiber has a weight average molecular weight in the range of 1000 g/mol to 2000 g/mol. In various additional embodiments as otherwise described herein, the soluble dietary fiber has a weight average molecular weight in the range of 1000 to 2250 g/mol, or 1000 g/mol to 1800 g/mol, or 1000 g/mol to 1600 g/mol, or 1200 to 2500 g/mol, or 1200 to 2250 g/mol, or 1200 g/mol to 2000 g/mol, or 1200 g/mol to 1800 g/mol, or 1200 g/mol to 1600 g/mol, or 1400 to 2500 g/mol, or 1400 to 2250 g/mol, or 1400 g/mol to 2000 g/mol, or 1400 g/mol to 1800 g/mol, or 1600 to 2500 g/mol, or 1600 to 2250 g/mol, or 1600 g/mol to 2000 g/mol, or 1800 g/mol to 2500 g/mol, or 1800 to 2250 g/mol, or 2000 g/mol to 2500 g/mol. As used herein, molecular weight of soluble dietary fibers are determined by gel permeation chromatography, using narrow standard pullulans as standards.

In certain embodiments as otherwise described herein, the soluble dietary fiber comprises certain amounts of mono- and/or disaccharides. This will typically be chiefly dextrose and dextrose disaccharides such as maltose and isomaltose, but the person of ordinary skill in the art will appreciate that minor amounts of other mono- and/or disaccharides may be present. In certain embodiments as otherwise described herein, the total amount of mono- and disaccharides is up to 25 wt % on a dry solids basis, e.g., up to 20 wt %. In certain embodiments, a soluble dietary fiber as otherwise described herein can have a relatively lower amount of mono- and disaccharides, e.g., no more than 15 wt %, no more than 10 wt %. In some embodiments, the soluble dietary fiber has no more than 2 wt % total mono- and disaccharides, or even no more than 1 wt % total mono- and disaccharides. Soluble dietary fibers having relatively low amounts of mono- and disaccharides can provide enhancement of sweetness and/or alteration of flavor perception without themselves providing significant sweetness to a food or beverage product.

In certain embodiments as otherwise described herein, there is a relatively significant amount of mono- and/or disaccharides in the soluble dietary fiber. For example, in certain embodiments as otherwise described herein, the total amount of mono- and disaccharides is in the range of 5 wt % to 25 wt %, For example, in certain such embodiments, the total amount of mono- and disaccharides is in the range of 10 wt % to 20 wt %, or 15 wt % to 25 wt % on a dry solids basis. The total amount of mono- and disaccharides can serves to provide additional sweetness to the food or beverage product. Notably, however, in systems in which sweetness is enhanced by the soluble dietary fiber, this is an amount in excess of the sweetness provided by the soluble dietary fiber itself.

In certain embodiments as otherwise described herein, the soluble dietary fiber has a linkage pattern comprising:
25-45% terminally-linked glucopyranosyi residues;
10-22% 6-linked glucopyranosyl residues;
13-32% 4-linked glucopyranosyl residues;
2-11% 3-linked glucopyranosyl residues;
3-13% 4,6-linked glucopyranosyl residues;
1-5% 3,6-linked glucopyranosyl residues;
0.5-4% 2,4-linked glucopyranosyl residues.

In certain embodiments as otherwise described herein, the soluble dietary fiber has a linkage pattern comprising:
29-45% terminally-linked glucopyranosyl residues;
10-22% 6-linked glucopyranosyl residues;
13-27% 4-linked glucopyranosyl residues;
2-11% 3-linked glucopyranosyl residues;
3-13% 4,6-linked glucopyranosyl residues;
1-5% 3,6-linked glucopyranosyl residues;
0.5-4% 2,4-linked glucopyranosyl residues.

Linkage patterns are determined using the method of York et al., Methods Enzymol. 116, 3-40 (1985), which is hereby incorporated by reference in its entirety. The method proceeds by permethylating the oligosaccharide, followed by quantitative hydrolysis and acetylation. This results in monomeric species that are acetylated where they were bound to other residues in the oligosaccharide, and methylated everywhere else. The mixture of the monomeric species can be analyzed by gas chromatography to determine relative amounts of different types of linked monomers. All linkages quantified in this disclosure can be determined using this method.

As used herein, a terminal residue is a residue that has only a single linkage to the rest of the oligosaccharide of which is it is a part. A 1,X-linked residue is one that is linked to the rest of the oligosaccharide of which it is a part at through its 1-position and its X-position (i.e., to two other residues). A 1,X,Y-linked residue is one that it is linked to the rest of the oligosaccharide of which it is a part through its 1-position, its X-position, and its Y-position (i.e., to three other residues). As used herein, the term “oligosaccharide” includes disaccharides, trisaccharides, and oligomers of higher degrees of polymerization up to 30. Linkage percentages are provided as the fraction of the total number of terminally-linked residues, di-linked residues and tri-linked residues.

The soluble dietary fiber materials of the disclosure can have a variety of fiber contents. “Fiber content” as the term is used herein is the amount of fiber by weight on a dry solids basis as measured by AOAC 2001.03. As used herein, a soluble dietary fiber has a fiber content of at least 60%. In certain embodiments as otherwise described herein, the soluble dietary fiber has a fiber content of at least 65%. For example, in certain embodiments, a soluble dietary fiber as otherwise described has a fiber content of at least 70%, e.g., at least 75%, at least 80%, or even at least 85%. For example, in various embodiments as otherwise described herein, a soluble dietary fiber has a fiber content in the range of 70% to 95% fiber, e.g., in the range of 70% to 90%, or 70% to 85%, or 70% to 80%. In other embodiments as otherwise described herein, a soluble dietary fiber has a fiber content in the range of 65 to 85% fiber, e.g., in the range of 65% to 80%, or in the range of 65% to 75%.

The soluble dietary fibers of the disclosure can be made in a variety of ways. For example, in certain embodiments, the soluble dietary fiber can be made by a process that includes providing a saccharide feed comprising at least 95% (e.g., at least 97%, at least 98%, or at least 99%) of dextrose and/or dextrose oligomers on a dry solids basis; reacting the saccharide feed in the presence of water and in the substantial absence of sugar alcohols at a total solids concentration of at least 80 wt % and a temperature of at least 120° C. with at least one acid catalyst that accelerates the rate of cleavage and formation of glucosyl bonds for a time sufficient to produce a product composition having a fiber content of at least 60%.

The saccharide feed can be provided by a variety of materials. In certain embodiments, it has a significant content of linear dextrose oligomers, i.e., oligomers in which dextrose residues are bonded only by 1,4-alpha linkages. In certain embodiments as otherwise described herein, the saccharide feed comprising at least 95% (e.g., at least 97%, at least 98%, or at least 99%) of dextrose and/or linear dextrose oligomers on a dry solids basis. Starch hydrolysate can be suitably used as feed compositions, e.g., having dextrose equivalence values in the range of 26-95, e.g., 26-50, 40-70, or 60-95. These can have varying amounts of dextrose, maltose and higher dextrose oligomers. A variety of starch sources are suitable, e.g., corn, rice, wheat, tapioca and potato. Higher purity dextrose (e.g., at least 97%, at least 98% or at least 99%) is also suitable as a feed composition.

The saccharide feed is reacted in the presence of water at a total solids concentration of at least 80%. The use of high solids concentration will drive the reaction towards condensation to build to a desired molecular weight (e.g., as described above) and to provide condensation of dextrose residues with one another. Notably, this condensation can provide a variety of different types of bonds, including non-1,4-alpha glucosyl bonds that are not so easily digested by the human digestive system. However, it is desirable to have some water present to hydrolyze a proportion of existing 1,4-alpha bonds in the feed (e.g., in linear dextrose oligomers). The person of ordinary skill in the art will select a solids content in conjunction with other process conditions to provide a desired soluble dietary fiber. For example, in certain embodiments as otherwise described herein, the reaction is performed at a total solids concentration of at least 85%, or even at least 90%. In various embodiments as otherwise described herein, the reaction is performed at a total solids concentration the range of 80 wt % to 99 wt %, e.g., 85-99 wt % A, or 90-99 wt %, or 93-99 wt %, or 80-98 wt %, or 85-98 wt %, or 90-98 wt %, or 93-98 wt %, or 80-96 wt %, or 85-96 wt %, or 90-96 wt %, or 93-96 wt %.

Of course, a saccharide feed can be provided at a relatively lower solids content (e.g., a pumpable syrup at 60-70%), then concentrated under the reaction conditions to the ultimate desired solids content for the reaction. The reaction can be performed while allowing escape of water (e.g., passively by venting or actively under vacuum), to not only concentrate a lower solids feed but also to drive the condensation by removal of water. It can be desirable to add portions of water to maintain the solids content at a desirable level (e.g., 93-98 wt % or any other amount described above) as water is removed from the system.

As condensation will produce water, the reaction can be performed while allowing water to escape the system, e.g., passively through venting the system, or actively using vacuum pumping.

Notably, the reaction is performed in the substantial absence of sugar alcohols, as is consistent with the fact that the soluble dietary fibers of the disclosure are not “polydextrose.” As used herein, a “substantial absence of sugar alcohols” means no more than 0.5 wt % of the feed. Desirably, the reaction is performed with no more than trace amounts of sugar alcohol present.

The reaction is performed at a temperature of at least 120° C. The person of ordinary skill in the art will select a solids content in conjunction with other process conditions to provide a desired soluble dietary fiber. For example, in certain embodiments as otherwise described herein, the reaction is performed at a temperature of at least 130° C. at least 140° C., or even at least 149° C. In various embodiments as otherwise described herein, the reaction is performed at a temperature in the range of 120° C. to 190° C., e.g., 120-180° C., or 120-170° C., or 130-190° C., or 130-180° C., or 130-170° C., or 140-190° C., or 140-180° C., or 140-170° C., or 140-190° C., or 140-180° C., or 140-170° C.

A variety of acid catalysts are known to catalyze the formation and hydrolysis of glucosyl bonds. For example, in certain embodiments, the at least one acid catalyst is selected from hydrochloric acid, phosphoric acid and sulfuric acid. In one embodiment, a combination of hydrochloric acid and phosphoric acid is used. Of course, other acid catalysts may also be suitable, e.g., citric acid, acetic acid, malic acid. However, in certain embodiments, no carboxylic acid catalyst is used. In certain embodiments, at least part of the acid catalyst is present from earlier processing (e.g., from the formation of a starch hydrolysate used as feed). The person of ordinary skill in the art will select an amount of acid suitable to provide a desired reaction rate in view of other reaction conditions. For example, in certain embodiments, sufficient acid is present to provide a reaction mixture pH of no more than 4, e.g., no more than 3 or no more than 2.5, such as in the range of 1.0-2.5.

The reaction time will vary depending on reaction conditions, as the person of ordinary skill in the art will appreciate. A wide variety of times can be used. However, in certain embodiments, the reaction time (i.e., time under the recited temperature, acid and solids content conditions) is in the range of 0.1-60 minutes, e.g., 0.1-30 minutes, or 0.1-15 minutes, or 0.1-10 minutes, or 0.5-60 minutes, or 0.5-30 minutes, or 0.5-15 minutes, or 0.5-10 minutes, or 1-60 minutes, or 1-30 minutes, or 1-15 minutes, or 1-10 minutes.

The reaction can be performed in any convenient system, e.g., in a batch reactor, or in a continuous reactor (e.g., a pipe) with continuous flow.

In certain embodiments, the soluble dietary fiber can be made by a process that includes providing a saccharide feed comprising at least 98% (or at least 99%) of dextrose and/or dextrose oligomers on a dry solids basis; reacting the saccharide feed in the presence of water and in the substantial absence of sugar alcohols at a total solids concentration of at least 90 wt % and a temperature of at least 149° C. with at least one acid catalyst that accelerates the rate of cleavage and formation of glucosyl bonds (e.g., at a pH no more than 4, or 1.0-2.5) for a time sufficient to produce a product composition having a fiber content of at least 60% (e.g., 0.1-15 minutes).

As described above, the reaction is performed such that the product composition (i.e., the reaction product) has a fiber content of at least 60%. In certain embodiments, the reaction is performed to provide the product composition with a fiber content that is about the same as that of the soluble dietary fiber (e.g., any value described above with respect to the soluble dietary fiber). However, in other embodiments, the product composition has an intermediate fiber content and a fractionation is performed to improve the fiber content to that of the soluble dietary fiber. Fractionation can be performed, for example, to selectively remove lower molecular weight components (e.g., DP1, or DP1+DP2, or DP1-DP3) as compared to higher molecular weight components. Membrane filtration or sequential simulated moving bed chromatography, for example, can be used in the fractionation.

Further processing by enzymes can also be used, e.g., before or after any fractionation steps. However, in certain embodiments no processing by enzyme is performed at any point during the reaction or purification sequence.

The person of ordinary skill in the art will appreciate that conventional methodologies can be used for further purifying the product, e.g., decolorization and ion exchange.

Suitable soluble dietary fibers and methods for making them are further described in U.S. Pat. Nos. 9,868,969, 9,957,537, 9,963,726 and 10,344,308, and in U.S. Patent Application Publication no. 2012/0034366, each of which is hereby incorporated herein by reference in its entirety. The person of ordinary skill in the art can further adapt the methods and materials as described herein based on these references.

Suitable soluble dietary fibers include those sold by Tate & Lyle Ingredients Americas LLC under the tradename PROMITOR®.

In other embodiments of the disclosure otherwise described herein, the soluble oligomeric component is a polydextrose. As is commonly understood, a “polydextrose” is an oligomeric acid-catalyzed condensation product of a mixture of 5-20 wt % sugar alcohol (typically sorbitol) and 80-95 wt % dextrose. For example, in certain desirable embodiments, the polydextrose is a condensation product of a mixture of about 89 wt % dextrose, about 10 wt % sorbitol and about 1 wt % citric acid.

A variety of food and beverage products can benefit from the enhancement of sweetness and/or the alteration of flavor perception as described herein. For example, in certain embodiments of the disclosure as otherwise described herein, the food or beverage product is a dairy product or a dairy alternative product (e.g., based on soy, oat, hemp, flax, cashew or tiger nut) Examples of suitable dairy products and dairy alternative products include yogurt, yogurt drinks, fermented dairy beverages, quarks, milk drinks, flavored milks, smoothies, ice cream, shakes, cottage cheese, sour creams, cremes fraiches, cottage cheese dressing, and dairy desserts, such as quarg and the whipped mousse-type products. This would include dairy products that are intended to be consumed directly (e.g., packaged smoothies) as well as those that are intended to be blended with other ingredients (e.g., blended smoothie). It can be used in pasteurized dairy products, such as ones that are pasteurized at a temperature from 160° F. to 285° F. Complete replacement of sugars in a dairy product is possible (which would be up to 24% of the total formula). The soluble dietary fiber as described herein is generally stable at acid pH values (the pH range of dairy beverages typically would be 2-8). And, notably, the soluble dietary fibers described herein are shown to provide enhancement of sweetness even in the highly-flavored context of a yogurt. The soluble dietary fibers described herein are shown to survive fermentation and heat processing typical in yogurt preparation.

In certain embodiments as otherwise described herein, the food or beverage product is a beverage, e.g., a sweetened beverage. Examples of suitable beverages include tea drinks, coffee drinks, sodas, flavored waters, punches, ades, protein- and/or peptide-enriched beverages, alcoholic beverages (e.g., beer, wine, cocktails, coolers, hard seltzers) and juices, including mixes, powders and concentrates thereof. The use of a soluble dietary fiber as described herein can in many cases overcome the clarity problems that result when other types of fiber are added to beverages. A complete replacement of sugars is possible (which could be, for example, up to 12% of the total formula). Because of the stability of the soluble dietary fiber as described herein at acid pH, it could be used in beverages having pH ranging from 2-7, for example. A soluble dietary fiber as described herein could be used in cold processed beverages and in pasteurized beverages. Advantageously in the context of sweetened drinks, the soluble oligomeric component can provide mouthfeel that is lost when sugar is substantially replaced with a high-intensity sweetener such as a rebaudioside.

But the enhancement of sweetness and/or the alteration of flavor perception as described herein can be desirable in a wide variety of food and beverage products. Certain embodiments of the food and beverage products as otherwise described herein are selected from baked foods, breakfast cereals, anhydrous coatings (e.g., ice cream compound coating, chocolate), dairy products, confections, spreads, jams and jellies, beverages, fillings, extruded and sheeted snacks, gelatin desserts, snack bars, cheese and cheese sauces, edible and water-soluble films, soups, syrups, sauces, dressings, creamers, icings, frostings, glazes, pet food, tortillas, meat and fish, dried fruit, infant and toddler food, and batters and breadings. A soluble dietary fiber as described herein can be present in the food product for one or more purposes (other than the effects on sweetness and/or flavor as described herein), such as a replacement or supplement for conventional carbohydrate, e.g., a complete or partial replacement for sweetener solids, or as a source of dietary fiber. Specific examples of foods in which a soluble dietary fiber as described herein can be used include processed foods such as bread, cakes, cookies, crackers, extruded snacks, soups, frozen desserts, fried foods, pasta products, potato products, rice products, corn products, wheat products, dairy products, yogurts, confectioneries, hard candies, nutritional bars, breakfast cereals, and beverages. A food or beverage product containing a soluble dietary fiber as described herein can have a lower caloric content, a lower glycemic response, lower glycemic index, and lower glycemic load than a similar food or beverage product in which a conventional carbohydrate, such as corn syrup, is used. Similarly, a food or beverage product containing a soluble dietary fiber as described herein can have an increased fiber content as compared to a similar food or beverage product in which a conventional carbohydrate, such as corn syrup, is used. In cases where the food or beverage product is sweetened, at least part of the sweetness can be provided be one or more rebaudiosides as generally described herein.

A soluble dietary fiber as described herein can be used as an ingredient in food or beverage products as a syrup, or it can first be concentrated to form syrup solids. In either form, it can be used in a number of ways, for example, as described herein.

A soluble dietary fiber as described herein can be added to food or beverage products as a source of soluble fiber. It can increase the fiber content of food or beverage products without having a negative impact on flavor, mouth feel, or texture.

The functionality of a soluble dietary fiber as described herein can be similar to corn syrup and sugar, which makes it suitable for complete or partial replacement of various nutritive sweeteners in food or beverage products. For example, a soluble dietary fiber as described herein can be used for total or partial replacement of sucrose, high fructose corn syrup (HFCS), fructose, dextrose, regular corn syrup, or corn syrup solids in food products. As one particular example, a soluble dietary fiber as described herein (e.g., in syrup or solid form) can be used to replace other sweetener solids on a 1:1 basis, up to a complete replacement of the sugar solids. At high sweetener solids replacement levels, the sweetness of the food or beverage product could be decreased, but mouth feel can remain substantially the same, while sugar and calorie content would be reduced. Also, a soluble dietary fiber as described herein could be used as a bulking agent, replacing fat, flour, or other ingredients in a food or beverage product.

A soluble dietary fiber as described herein can be used in food or beverage products in combination with resistant starch or polydextrose to boost the fiber content of the food product, enhance physiological benefit from consumption of the product, reduce the caloric content, and/or enhance the nutritional profile of the product.

A soluble dietary fiber as described herein can be used in food or beverage products in combination with bulking agents, such as sugar alcohols or maltodextrins, to reduce caloric content and/or to enhance nutritional profile of the product. A soluble dietary fiber as described herein can also be used as a partial replacement for fat in food or beverage products.

A soluble dietary fiber as described herein can be used in food or beverage products as a tenderizer or texturizer, to increase crispness or snap, to improve eye appeal, and/or to improve the rheology of dough, batter, or other food compositions. A soluble dietary fiber as described herein can also be used in food products as a humectant, to increase product shelf life, and/or to produce a softer, moister texture. It can also be used in food products to reduce water activity or to immobilize and manage water. Additional uses of the oligomer composition as described herein include: to replace egg wash and/or to enhance the surface sheen of a food product, to alter flour starch gelatinization temperature, to modify the texture of the product, and to enhance browning of the product.

At least in some embodiments of the invention, a soluble dietary fiber as described herein has one or more of the following advantages: high solubility, which makes it relatively easy to incorporate into food compositions, such as batters and doughs; stability under elevated temperatures and/or acidic pH (some other soluble fibers, such as inulin, are not as stable), lower sweetness, clean flavor, and clear color. The properties of a soluble dietary fiber as described herein can allow food or beverage products in which it is used to have a so-called “clean label.”

A soluble dietary fiber as described herein can be used in a variety of types of food or beverage products. One type of food product in which a soluble dietary fiber as described herein can be very useful is bakery products (i.e., baked foods), such as cakes, brownies, cookies, cookie crisps, muffins, breads, and sweet doughs. Conventional bakery products can be relatively high in sugar and high in total carbohydrates. The use of a soluble dietary fiber as described herein as an ingredient in bakery products can help lower the sugar and carbohydrate levels, as well as reduce the total calories, while increasing the fiber content of the bakery product.

There are two main categories of bakery products: yeast-raised and chemically-leavened. In yeast-raised products, like donuts, sweet doughs, and breads, a soluble dietary fiber as described herein can be used to replace sugars, but a small amount of sugar may still be desired due to the need for a fermentation substrate for the yeast or for crust browning. A soluble dietary fiber as described herein in solid form could be added in a manner similar to nutritive dry sweeteners, with other dry ingredients, and would require no special handling. A soluble dietary fiber as described herein can be added with other liquids as a direct replacement for syrups or liquid sweeteners. The dough would then be processed under conditions commonly used in the baking industry including being mixed, fermented, divided, formed or extruded into loaves or shapes, proofed, and baked or fried. The product can be baked or fried using conditions similar to traditional products. Breads are commonly baked at temperatures ranging from 420° F. to 520° F. for 20 to 23 minutes and doughnuts can be fried at temperatures ranging from 400-415° F., although other temperatures and times could also be used. High intensity sweeteners can be added to doughs as required to obtain optimum sweetness and flavor profile.

Chemically leavened products typically have more sugar and may contain have a higher level of a soluble dietary fiber as described herein. A finished cookie can contain 30% sugar, which could be replaced, entirely or partially, with a soluble dietary fiber as described herein. These products could have a pH of 4-9.5, for example. The moisture content can be between 2-40%, for example.

A soluble dietary fiber as described herein is readily incorporated and may be added to the fat at the beginning of mixing during a creaming step or in any method similar to the syrup or dry sweetener that it is being used to replace. The product would be mixed and then formed, for example by being sheeted, rotary cut, wire cut, or through another forming process. The products would then be baked under typical baking conditions, for example at 200-450° F.

A soluble dietary fiber as described herein can also be used to form sugar glasses in the amorphous state, to adhere particles to baked goods, and/or used to form a film or coating which enhances the appearance of a baked good. A soluble dietary fiber as described herein in solid form, like other amorphous sugars, form glasses with heating and subsequent cooling to a temperature below their glass transition temperature.

Another type of food or beverage product in which a soluble dietary fiber as described herein can be used is breakfast cereal. For example, a soluble dietary fiber as described herein could be used to replace all or part of the sugar in extruded cereal pieces and/or in the coating on the outside of those pieces. The coating is typically 30-60% of the total weight of the finished cereal piece. A soluble dietary fiber as described herein can be applied in a spray or drizzled on, for example. The formula for the coating can be as simple as a 75% solution of a soluble dietary fiber as described herein. A soluble dietary fiber as described herein could also be blended with sugar at various percentages, or with other sweeteners or polyols. The extra moisture could then be evaporated in a low heat oven. In an extruded piece, a soluble dietary fiber as described herein in solid form could be added directly with the dry ingredients, or a soluble dietary fiber as described herein in syrup form could be metered into the extruder with water or separately. A small amount of water could be added in the extruder, and then it could pass through various zones ranging from 100° F. to 300° F. Optionally, other sources of fiber such as resistant starch can be used in the extruded piece. Using a soluble dietary fiber as described herein would create a different texture than other fiber sources. Using it alone or in combination with other fibers may alter the texture to create product diversity.

Another type of food product in which a soluble dietary fiber as described herein can be used is spreads, such as nut-based spreads. Examples include highly sweetened spreads such as sweetened hazelnut spreads (e.g., NUTELLA); and nut butters such as peanut butter, almond butter and cashew butter, which are often sweetened (albeit to a lower degree than NUTELLA). Of course, soluble dietary fiber can be used as described herein even in unsweetened nut butters. The use of soluble dietary fiber can provide enhanced sweetness and/or flavor as described herein, and can also provide desirable texture to the spread.

Another type of food product in which a soluble dietary fiber as described herein can be used is confections. Examples of confections in which it can be used include hard candies, fondants, nougats and marshmallows, gelatin jelly candies or gummies, jellies, wine gums, chocolate confections such as chocolate bars, truffles, and chocolate coatings, confectionery coating, licorice, chewing gum, caramels and toffees, chews, mints, tableted confections, hard-panned and soft panned products, and fruit snacks. In fruit snacks, a soluble dietary fiber as described herein could be used in combination with fruit juice. The fruit juice would provide the majority of the sweetness, and the soluble dietary fiber as described herein would reduce the total sugar content and add fiber. The syrup can be added to the initial candy slurry and heated to the finished solids content. The slurry could be heated from 200-305° F. to achieve the finished solids content. Acid could be added before or after heating to give a finished pH of 2-7. A soluble dietary fiber as described herein could be used as a replacement for 0-100% of the sugar and 1-100% of the corn syrup or other sweeteners (e.g., tapioca syrup, pea syrup) present.

Another type of food product in which a soluble dietary fiber as described herein can be used is jams and jellies. Jams and jellies are made from fruit. A jam contains fruit pieces, while jelly is made from fruit juice. A soluble dietary fiber as described herein can be used in place of sugar or other sweeteners as follows: Weigh fruit and juice into a tank. Premix sugar, resistant corn syrup and pectin. Add the dry composition to the liquid and cook to a temperature of 214-220° F. Hot fill into jars and retort for 5-30 minutes.

Another type of food product in which a soluble dietary fiber as described herein can be used is high solids fillings. Examples of high solids fillings in which it can be used include fillings in snack bars, toaster pastries, donuts, and cookies. The high solids filling could be an acid/fruit filling or a savory filling, for example. It could be added to products that would be consumed as is, or products that would undergo further processing, by a food processor (additional baking) or by a consumer (bake stable filling). In some embodiments, the high solids fillings would have a solids concentration between 67-90%. The solids could be entirely replaced with a soluble dietary fiber as described herein, or it could be used for a partial replacement of the other sweetener solids present (e.g., replacement of current solids from 5-100%). Typically fruit fillings would have a pH of 2-6, while savory fillings would be between 4-8 pH. Fillings could be prepared cold, or heated at up to 250° F. to evaporate to the desired finished solids content.

Another type of food product in which a soluble dietary fiber as described herein can be used is extruded and sheeted snacks. Examples of extruded and sheeted snacks in which it can be used include puffed snacks, crackers, tortilla chips, and corn chips. In preparing an extruded piece, a soluble dietary fiber as described herein (e.g., in solid form) would be added directly with the dry products. A small amount of water would be added in the extruder, and then it would pass through various zones ranging from 1000° F. to 300° F. A soluble dietary fiber as described herein could be added at levels from 0-50% of the dry products mixture. A soluble dietary fiber as described herein in liquid form could also be added at one of the liquid ports along the extruder. The product would come out at either a low moisture content (5%) and then baked to remove the excess moisture, or at a slightly higher moisture content (10%) and then fried to remove moisture and cook out the product. Baking could be at temperatures up to 500° F. for 20 minutes. Baking would more typically be at 3530° F. for 10 minutes. Frying would typically be at 350° F. for 2-5 minutes. In a sheeted snack, the resistant corn syrup solids could be used as a partial replacement of the other dry ingredients (e.g., flour). It could be from 0-50% of the dry weight. The product would be dry mixed, and then water added to form cohesive dough. The product mix could have a pH from 5 to 8. The dough would then be sheeted and cut and then baked or fried. Baking could be at temperatures up to 500° F. for 20 minutes. Frying would typically be at 350° F. for 2-5 minutes. Another potential benefit from the use of a soluble dietary fiber as described herein is a reduction of the fat content of fried snacks by as much as 15% when it is added as an internal ingredient or as a coating on the outside of a fried food.

Another type of food product in which a soluble dietary fiber as described herein can be used is gelatin desserts. The ingredients for gelatin desserts are often sold as a dry mix with gelatin as a gelling agent. The sugar solids could be replaced partially or entirely with a soluble dietary fiber as described herein in solid form in the dry mix. The dry mix can then be mixed with water and heated to 212° F. to dissolve the gelatin and then more water and/or fruit can be added to complete the gelatin dessert. The gelatin is then allowed to cool and set. Gelatin can also be sold in shelf stable packs. In that case the stabilizer is usually carrageenan-based. As stated above, a soluble dietary fiber as described herein can replace up to 100% of the other sweetener solids. The dry ingredients are mixed into the liquids and then pasteurized and put into cups and allowed to cool and set. The cups usually have a foil top.

Another type of food product in which a soluble dietary fiber as described herein can be used is cheese, cheese sauces, and other cheese products, as well as their dairy alternative versions. Examples of cheese, cheese sauces, and other cheese and dairy alternative products in which it can be used include lower milk solids cheese, lower fat cheese, and calorie reduced cheese. In block cheese, it can help to improve the melting characteristics, or to decrease the effect of the melt limitation added by other ingredients such as starch. It could also be used in cheese sauces, for example as a bulking agent, to replace fat, milk solids, or other typical bulking agents.

Another type of food product in which a soluble dietary fiber as described herein can be used is films that are edible and/or water soluble. Examples of films in which it can be used include films that are used to enclose dry mixes for a variety of foods and beverages that are intended to be dissolved in water, or films that are used to deliver color or flavors such as a spice film that is added to a food after cooking while still hot. Other film applications include, but are not limited to, fruit and vegetable leathers, and other flexible films.

Another type of food product in which a soluble dietary fiber as described herein can be used is soups, syrups, sauces, and dressings. A typical dressing could be from 0-50% oil, with a pH range of 2-7. It could be cold processed or heat processed. It would be mixed, and then stabilizer would be added. A soluble dietary fiber as described herein could easily be added in liquid or dry form with the other ingredients as needed. The dressing composition may need to be heated to activate the stabilizer. Typical heating conditions would be from 170-200° F. for 1-30 minutes. After cooling, the oil is added to make a pre-emulsion. The product is then emulsified using a homogenizer, colloid mill, or other high shear process.

Sauces can have from 0-10% oil and from 10-50% total solids, and can have a pH from 2-8. Sauces can be cold processed or heat processed. The ingredients are mixed and then heat processed. A soluble dietary fiber as described herein could easily be added in liquid or dry form with the other ingredients as needed. Typical heating would be from 170-200° F. for 1-30 minutes.

Soups are more typically 20-50% solids and in a more neutral pH range (4-8). They can be a dry mix, to which a soluble dietary fiber as described herein in solid form could be added, or a liquid soup which is canned and then retorted. In soups, a soluble dietary fiber as described herein could be used up to 50% solids, though a more typical usage would be to deliver 5 g of fiber/serving.

Syrups can incorporate a soluble dietary fiber as described herein as up to a 100% replacement of the sugar solids. Typically that would be 12-20% of the soluble dietary fiber on an as-is basis. A soluble dietary fiber as described herein would be added with the water and then pasteurized and hot filled to make the product safe and shelf stable (typically 185° F. for one minute pasteurization).

Another type of food product in which a soluble dietary fiber as described herein can be used is coffee creamers. Examples of coffee creamers in which it can be used include both liquid and dry creamers. A dry blended coffee creamer can be blended with commercial creamer powders of the following fat types: soybean, coconut, palm, sunflower, or canola oil, or butterfat. These fats can be non-hydrogenated or hydrogenated. A soluble dietary fiber as described herein in solid form can be added as a fiber source, optionally together with fructo-oligosaccharides, polydextrose, inulin, maltodextrin, resistant starch, sucrose, and/or conventional corn syrup solids. The composition can also contain high intensity sweeteners, such as sucralose, acesulfame potassium, aspartame, or combinations thereof. These ingredients can be dry blended to produce the desired composition.

A spray dried creamer powder is a combination of fat, protein and carbohydrates, emulsifiers, emulsifying salts, sweeteners, and anti-caking agents. The fat source can be one or more of soybean, coconut, palm, sunflower, or canola oil, or butterfat. The protein can be sodium or calcium caseinates, milk proteins, whey proteins, wheat proteins, or soy proteins. The carbohydrate can be a soluble dietary fiber as described herein alone or in combination with fructo-oligosaccharides, polydextrose, inulin, resistant starch, maltodextrin, sucrose, or corn syrup. The emulsifiers can be mono- and diglycerides, acetylated mono- and diglycerides, or propylene glycol monoesters. The salts can be trisodium citrate, monosodium phosphate, disodium phosphate, trisodium phosphate, tetrasodium pyrophosphate, monopotassium phosphate, and/or dipotassium phosphate. The composition can also contain high intensity sweeteners, such as sucralose, acesulfame potassium, aspartame, or combinations thereof. Suitable anti-caking agents include sodium silicoaluminates or silica dioxides. The products are combined in slurry, optionally homogenized, and spray dried in either a granular or agglomerated form.

Liquid coffee creamers are simply a homogenized and pasteurized emulsion of fat (either dairy fat or hydrogenated vegetable oil), some milk solids or caseinates, corn syrup, and vanilla or other flavors, as well as a stabilizing blend. The product is usually pasteurized via HTST (high temperature short time) at 185° F. for 30 seconds, or UHT (ultra-high temperature), at 285° F. for 4 seconds, and homogenized in a two stage homogenizer at 500-3000 psi first stage, and 200-1000 psi second stage. The coffee creamer is usually stabilized so that it does not break down when added to the coffee.

Another type of food product in which a soluble dietary fiber as described herein can be used is food coatings such as icings, frostings, and glazes. In icings and frostings, a soluble dietary fiber as described herein can be used as a sweetener replacement (complete or partial) to lower caloric content and increase fiber content. Glazes are typically about 70-90% sugar, with most of the rest being water, and a soluble dietary fiber as described herein can be used to entirely or partially replace the sugar. Frosting typically contains about 2-40% of a liquid/solid fat combination, about 20-75% sweetener solids, color, flavor, and water. A soluble dietary fiber as described herein can be used to replace all or part of the sweetener solids, or as a bulking agent in lower fat systems.

Another type of food product in which a soluble dietary fiber as described herein can be used is pet food, such as dry or moist dog food. Pet foods are made in a variety of ways, such as extrusion, forming, and formulating as gravies. A soluble dietary fiber as described herein could be used at levels of 0-50% in each of these types.

Another type of food product in which a soluble dietary fiber as described herein can be used is tortillas, which usually contain flour and/or corn meal, fat, water, salt, and fumaric acid. A soluble dietary fiber as described herein could be used to replace flour or fat. The ingredients are mixed and then sheeted or stamped and cooked. This addition could be used to add fiber or extend the shelf life.

Another type of food product in which a soluble dietary fiber as described herein can be used is fish and meat. Conventional corn syrup is already used in some meats, so a soluble dietary fiber as described herein can be used as a partial or complete substitute. For example, a soluble dietary fiber as described herein could be added to brine before it is vacuum tumbled or injected into the meat. It could be added with salt and phosphates, and optionally with water binding ingredients such as starch, carrageenan, or soy proteins. This would be used to add fiber, a typical level would be 5 g/serving which would allow a claim of excellent source of fiber.

Another type of food product in which a soluble dietary fiber as described herein can be used is a meat analogue or meat alternative. Meat analogues and meat alternatives are food products used as meat substitutes and include plant-based ingredients. Meat analogs and meat alternatives can be formed without the use of animal-based ingredients, or alternatively can be made by combining animal-based ingredients with plant-based ingredients (e.g., proteins, fibers, and/or fats). Examples include texturized vegetable protein, tempeh, seitan and pea protein-based foods, as well as animal flesh analogs of the types made by Impossible Foods and Beyond Meat. Soluble dietary fiber as described above may be introduced as a modifier to any of flavor, texture and/or nutrition. For example, soluble dietary fiber may be added to texturized protein products to be used as ingredients in meat analogues, addition may be into the mass that is extruded to create the texturized protein, or after the mass has been extruded. Soluble dietary fiber may be added in a meat analogue with or without texturized protein, and it may be added pre-or post-extrusion of the meat analogue mass, or pre-or post-blending or mixing of ingredients in the composition, or pre-or post-processing. Soluble dietary fiber as described above may be homogenously dispersed throughout the product or concentrated in particular aspects of the product, for example in aspects intended to mimic animal-based components such as muscle meat, cartilage, connective and/or adipose tissue.

Another type of food product in which a soluble dietary fiber as described herein can be used is dried (infused) fruit. Many kinds of dried fruit are only stable and palatable if they are infused with sugar. A soluble dietary fiber as described herein can be substituted for all or part of the sugar. For example, a soluble dietary fiber as described herein could be added to the brine used to infuse the fruit before drying. Stabilizing agents such as sulfates can be used in this brine as well.

Another type of food product in which a soluble dietary fiber as described herein can be used is infant and toddler food. A soluble dietary fiber as described herein could be used as a replacement or a supplement to one or more conventional ingredients for such food. Because of its mild flavor and clear color, it could be added to a variety of baby foods to reduce sugar and increase fiber content.

Another type of food product in which a soluble dietary fiber as described herein can be used is batters and breadings, such as the batters and breadings for meat. This could be done by replacing all or part of the dry components of the batter and/or breading (e.g., flour type ingredients) with a soluble dietary fiber as described herein, or to use in combination with addition to the meat muscle or fried food itself. This could be used as a bulking agent, for fiber addition, or to reduce fat in the fried food.

Food products as disclosed herein can be used to help control the blood glucose concentration in mammals, such as humans, that suffer from diabetes. When the food product is consumed by the mammal, a soluble dietary fiber as described herein in the food product can cause a more moderate relative glycemic response in the bloodstream (i.e. as opposed to similar food products containing corn syrup), which can be beneficial for diabetes patients. “Control” in this context should be understood as a relative term; i.e., the glycemic response can be improved relative to that occurring when the same mammal consumes a similar food product that contains corn syrup, although the glycemic response may not necessarily be equivalent to what would be observed in a mammal that does not suffer from diabetes, or in a mammal that does not eat a food product at all.

In certain embodiments, the food product is a bar (e.g., a snack bar), for example, a meal replacement bar, a nutrition bar, a granola bar, a cereal bar, a grain bar, a protein bar or a nut bar. A soluble dietary fiber as described herein could be used in any part of the snack bars, such as in the high solids filling, the binding syrup or the particulate portion. A complete or partial replacement of sugar in the binding syrup is possible with a soluble dietary fiber as described herein. The binding syrup is typically from 50-90% solids and applied at a ratio ranging from 10% binding syrup to 90% particulates, to 70% binding syrup to 30% particulates. The binding syrup is made by heating a solution of sweeteners, bulking agents and other binders (like starch) to 160-230° F. (depending on the finished solids needed in the syrup). The binding syrup is then mixed with the particulates to coat the particulates, providing a coating throughout the matrix. A soluble dietary fiber as described herein could also be used in the particulates themselves. This could be an extruded piece, directly expanded or gun puffed. It could be used in combination with another grain ingredient, corn meal, rice flour or other similar ingredient.

Food and beverage products as described herein can be provided in a variety of forms. For example, in various embodiments of the disclosure, a food or beverage product can be provided in a ready-to-consume form, in a frozen form, in an uncooked form, in the form of a concentrate or in the form of a dry mix. In various embodiments these can be suitable for further preparation, e.g., heating, cooking, reconstitution, dilution, in order to provide a food or beverage product to be consumed.

For example, in certain embodiments as otherwise described herein, the food or beverage product is in the form of a dry mix (e.g., as a powder). A wide variety of food and beverage products can be provided as powders, e.g., beverages (such as fruit beverages like punches and ades, coffees, teas, cocoas and chocolate drinks, protein- and/or peptide-enriched beverages), meal replacement shakes, soups, sauces, dressings, desserts (e.g., gelatins, custards like flan, and puddings), milk and milk substitutes (dairy or plant based, e.g., growth milk, infant formula), bakery mixes (e.g., cake mix, muffin mix, cookie mix). Of course, this listing is only exemplary; myriad other food and beverage products can be provided as a dry mix.

When the soluble oligomeric component is polydextrose, it can likewise be used in the many food and beverage products described above (although with effects that are often distinct from those of soluble dietary fiber).

Further description is provided with respect to the Examples, below. Four stevia sweeteners were used in the Examples: SSA is rebaudioside A 97%; SSB is a blend of stevioside, rebaudioside A, and rebaudioside B; SSC is a blend of rebaudioside A and rebaudioside B blend; and SSD is rebaudioside M 95%.

### Example 1—Soluble Dietary Fiber and SSC Stevia Sweetener

Rank-rating using 20-point horizontal line scale with a mark at each point was used to determine the sweetness of SSC (which includes a blend of rebaudioside A and rebaudioside B) with 5% PROMITOR® soluble dietary fiber (having less than 2% monosaccharides/disaccharides) (“SDF”) as compared to SSC alone, both in bottled water as perceived by untrained panelists. The SSC concentration ranged from 100-1500 ppm (i.e., of rebaudiosides). The panelists were first presented with 5 sucrose references at 2.5%, 5.0%, 7.5%, 10% and 12.5% in bottled water. The panelists were asked to familiarize themselves with the references before beginning the evaluation of the test samples. There was a 30 second enforced waiting period between the references and the test samples. The panelists were asked to taste the SSC/SDF samples, compare the sweetness to the references, and then rate the sweetness by placing a mark on the 20-point scale. The value appeared above the scale when marked. The panelists were able to adjust their rating. The panelists were then asked to rate their overall acceptance of the sample on a 7-point scale, their perception of the sugar-like quality of the sample on a 5-point scale, their perception of any off-taste on a 6-point scale, and a comment on any off-taste detected. There was a 30 second enforced waiting period between the test samples.

The references were served in four ounce soufflé cups labeled with the sucrose concentration at room temperature. The test samples were served in two ounce soufflé cups labeled with a 3-digit codes at room temperature. Water and unsalted cracker were available for the panelists to clear their palates.

Sweetness results were as follows; numbers in the cells indicate the number of panelists selecting the particular value of the left column for the indicated SSC sweetener concentration.

Without Soluble Dietary Fiber—Sweetness (units of Sucrose Equivalence Value, SEV):

| | 100 | 250 | 500 | 750 | 1000 | 1500 |
|---|---|---|---|---|---|---|
| SEV | ppm | ppm | ppm | ppm | ppm | ppm |
| 0 | 0 | 0 | 0 | 0 | 0 | 0 |
| 1 | 1 | 0 | 0 | 0 | 0 | 0 |
| 2 | 4 | 1 | 0 | 0 | 1 | 1 |
| 3 | 16 | 0 | 2 | 1 | 6 | 0 |
| 4 | 6 | 8 | 7 | 0 | 4 | 0 |
| 5 | 2 | 9 | 9 | 0 | 6 | 1 |
| 6 | 1 | 4 | 9 | 2 | 6 | 0 |
| 7 | 0 | 2 | 10 | 6 | 5 | 2 |
| 8 | 0 | 3 | 9 | 2 | 8 | 2 |
| 9 | 0 | 3 | 3 | 7 | 8 | 8 |
| 10 | 0 | 0 | 7 | 6 | 2 | 7 |
| 11 | 0 | 0 | 1 | 5 | 4 | 4 |
| 12 | 0 | 0 | 1 | 1 | 4 | 3 |
| 13 | 0 | 0 | 1 | 5 | 3 | 3 |
| 14 | 0 | 0 | 1 | 1 | 3 | 1 |
| 15 | 0 | 0 | 0 | 1 | 0 | 3 |
| 16 | 0 | 0 | 0 | 0 | 0 | 0 |
| 17 | 0 | 0 | 0 | 0 | 0 | 0 |
| 18 | 0 | 0 | 0 | 0 | 0 | 1 |
| 19 | 0 | 0 | 0 | 0 | 0 | 0 |
| 20 | 0 | 0 | 0 | 0 | 0 | 1 |
| mean | 2.86 | 5.21 | 6.69 | 9.42 | 7.45 | 10.41 |
| std dev | 0.92 | 1.74 | 2.43 | 2.56 | 3.18 | 3.38 |

With Soluble Dietary Fiber—Sweetness (units of Sucrose Equivalence Value, SEV):

| | 100 | 250 | 500 | 750 | 1000 | 1500 |
|---|---|---|---|---|---|---|
| SEV | ppm | ppm | ppm | ppm | ppm | ppm |
| 0 | 0 | 0 | 0 | 0 | 0 | 0 |
| 1 | 0 | 0 | 0 | 0 | 0 | 0 |
| 2 | 7 | 0 | 0 | 0 | 0 | 0 |
| 3 | 12 | 1 | 2 | 0 | 0 | 1 |
| 4 | 10 | 5 | 1 | 1 | 2 | 0 |
| 5 | 5 | 9 | 0 | 3 | 1 | 1 |
| 6 | 4 | 9 | 7 | 2 | 2 | 4 |
| 7 | 2 | 10 | 8 | 2 | 8 | 1 |
| 8 | 2 | 2 | 2 | 8 | 3 | 5 |
| 9 | 0 | 3 | 7 | 6 | 7 | 6 |
| 10 | 0 | 1 | 7 | 6 | 6 | 7 |
| 11 | 0 | 1 | 0 | 4 | 4 | 4 |
| 12 | 0 | 0 | 2 | 2 | 3 | 3 |
| 13 | 0 | 0 | 5 | 2 | 1 | 1 |
| 14 | 0 | 0 | 0 | 1 | 1 | 4 |
| 15 | 0 | 1 | 0 | 2 | 1 | 0 |
| 16 | 0 | 0 | 0 | 0 | 1 | 1 |
| 17 | 0 | 0 | 0 | 0 | 1 | 0 |
| 18 | 0 | 0 | 0 | 0 | 0 | 0 |
| 19 | 0 | 0 | 0 | 0 | 0 | 1 |
| 20 | 0 | 0 | 0 | 0 | 0 | 0 |
| mean | 3.71 | 6.16 | 8.17 | 8.96 | 9.08 | 9.60 |
| std dev | 1.62 | 2.22 | 2.68 | 2.61 | 2.92 | 3.23 |

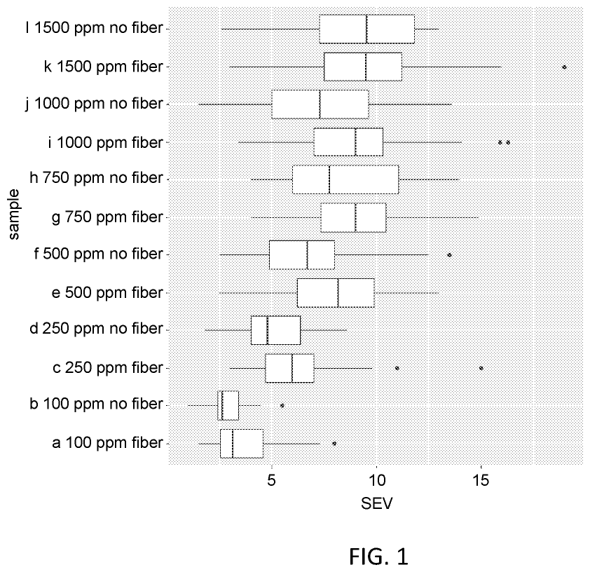

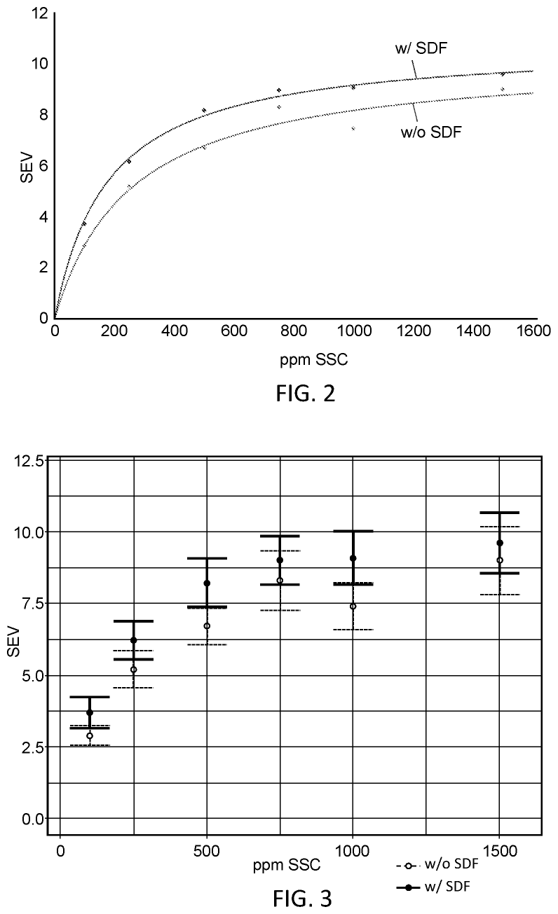

Sweetness data are summarized below, and in the graphs of FIGS. 1-3:

| | | 100 | 250 | 500 | 750 | 1000 | 1500 |
|---|---|---|---|---|---|---|---|
| fiber | SEV | ppm | ppm | ppm | ppm | ppm | ppm |
| Without SDF | mean | 2.9 | 5.2 | 6.7 | 8.3 | 7.4 | 9.0 |
| | variance | 0.8 | 3.0 | 5.9 | 7.7 | 10.1 | 10.1 |
| With SDF | mean | 3.7 | 6.2 | 8.2 | 9.0 | 9.1 | 9.6 |
| | variance | 2.6 | 4.9 | 7.2 | 6.8 | 8.5 | 10.6 |
| Student's t | | 2.80 | 2.03 | 2.83 | 1.01 | 2.66 | 0.77 |
| p-value | | <0.01 | 0.05 | <0.01 | 0.31 | <0.01 | 0.44 |

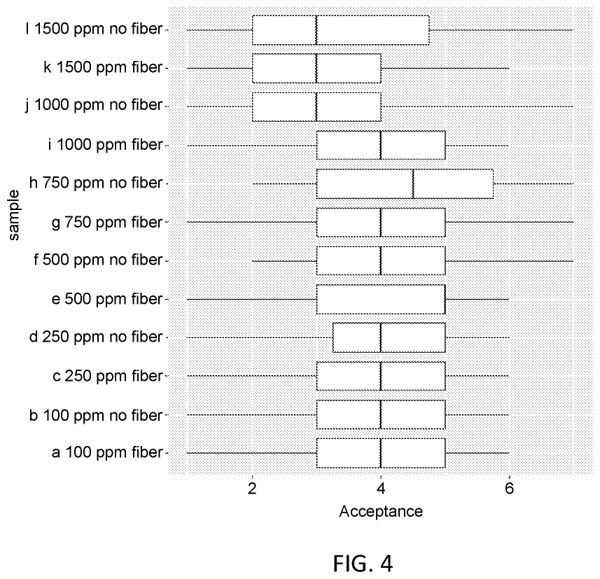

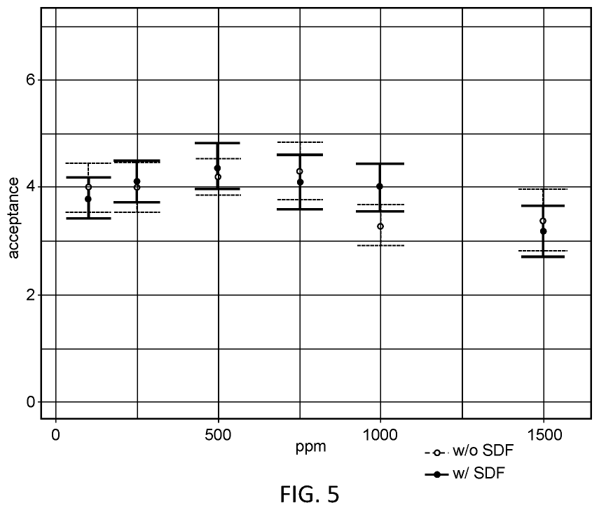

Data were also collected for overall acceptance on a 7-point scale. These are summarized in the Tables below and in FIGS. 4 and 5.

Without Soluble Dietary Fiber—Acceptance

| Overall | 100 | 250 | 500 | 750 | 1000 | 1500 |
|---|---|---|---|---|---|---|
| Acceptance | ppm | ppm | ppm | ppm | ppm | ppm |
| dislike very | 1 | 1 | 0 | 0 | 8 | 4 |
| much | | | | | | |
| dislike | 2 | 3 | 6 | 2 | 13 | 5 |
| moderately | | | | | | |
| dislike slightly | 6 | 4 | 13 | 10 | 13 | 8 |
| neither like or | 11 | 12 | 15 | 3 | 12 | 5 |
| dislike | | | | | | |
| like slightly | 6 | 6 | 15 | 7 | 10 | 6 |
| like moderately | 4 | 4 | 9 | 7 | 3 | 1 |
| like very much | 0 | 0 | 2 | 1 | 1 | 1 |
| like very much | 1 | 1 | 0 | 0 | 8 | 4 |
| mean | 4.03 | 4.03 | 4.23 | 4.33 | 3.27 | 3.37 |
| std dev | 1.25 | 1.27 | 1.32 | 1.42 | 1.52 | 1.56 |

With Soluble Dietary Fiber—Acceptance

| Overall | 100 | 250 | 500 | 750 | 1000 | 1500 |
|---|---|---|---|---|---|---|
| Acceptance | ppm | ppm | ppm | ppm | ppm | ppm |
| dislike very | 4 | 1 | 1 | 3 | 1 | 5 |
| much | | | | | | |
| dislike | 0 | 3 | 3 | 4 | 8 | 10 |
| moderately | | | | | | |
| dislike slightly | 11 | 9 | 8 | 8 | 5 | 5 |
| neither like or | 13 | 12 | 6 | 5 | 10 | 11 |
| dislike | | | | | | |
| like slightly | 13 | 12 | 13 | 11 | 12 | 6 |
| like moderately | 1 | 5 | 10 | 7 | 5 | 2 |
| like very much | 0 | 0 | 0 | 1 | 0 | 0 |
| like very much | 4 | 1 | 1 | 3 | 1 | 5 |
| mean | 3.81 | 4.10 | 4.39 | 4.08 | 3.95 | 3.23 |
| std dev | 1.23 | 1.23 | 1.38 | 1.61 | 1.40 | 1.46 |

Acceptance Summary

| | | 100 | 250 | 500 | 750 | 1000 | 1500 |
|---|---|---|---|---|---|---|---|
| fiber | | ppm | ppm | ppm | ppm | ppm | ppm |
| Without SDF | mean | 4.0 | 4.0 | 4.2 | 4.3 | 3.3 | 3.4 |
| | variance | 1.6 | 1.6 | 1.7 | 2.0 | 2.3 | 2.4 |
| With SDF | mean | 3.8 | 4.1 | 4.4 | 4.1 | 4.0 | 3.2 |
| | variance | 1.5 | 1.5 | 1.9 | 2.6 | 1.9 | 2.1 |
| Student's t | | −0.75 | 0.21 | 0.57 | −0.70 | 2.34 | −0.34 |
| p-value | | 0.45 | 0.84 | 0.57 | 0.48 | 0.02 | 0.71 |

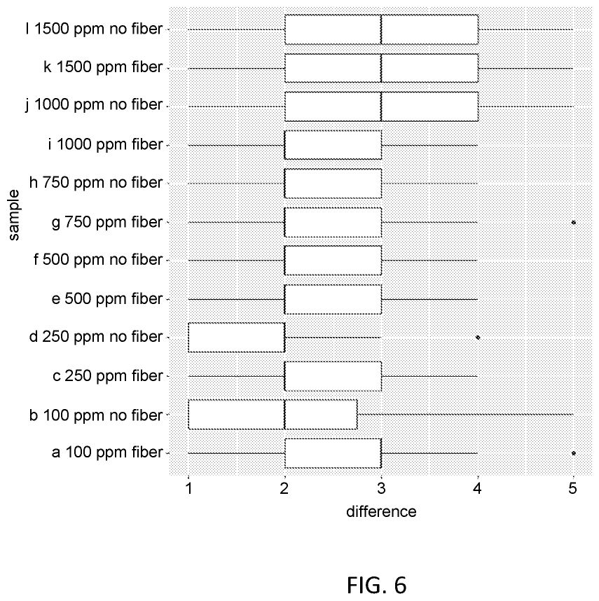

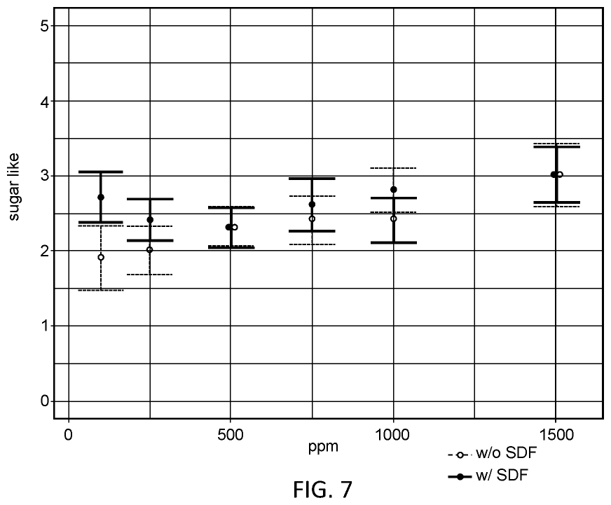

Data were also collected for panelists' perception of the sucrose-like quality of the sweetness, on a 5-point scale. These are summarized in the Table below and in FIGS. 6 and 7.

| | | 100 | 250 | 500 | 750 | 1000 | 1500 |
|---|---|---|---|---|---|---|---|
| fiber | | ppm | ppm | ppm | ppm | ppm | ppm |
| Without SDF | mean | 1.9 | 2.0 | 2.3 | 2.4 | 2.8 | 3.0 |
| | variance | 1.3 | 0.7 | 1.0 | 0.7 | 1.3 | 1.2 |
| With SDF | mean | 2.7 | 2.4 | 2.3 | 2.6 | 2.4 | 3.0 |
| | variance | 1.1 | 0.8 | 0.7 | 1.1 | 0.9 | 1.3 |
| Student's t | | 2.94 | 2.12 | 0.27 | 0.78 | −1.93 | −0.09 |
| p-value | | <0.01 | 0.04 | 0.78 | 0.43 | 0.05 | 0.92 |

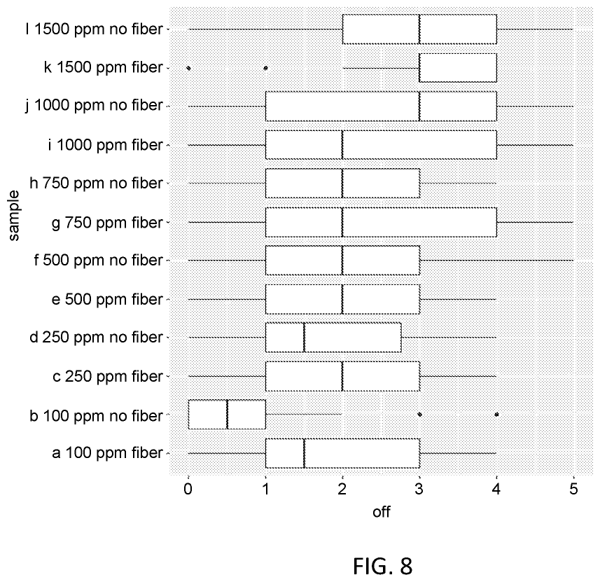

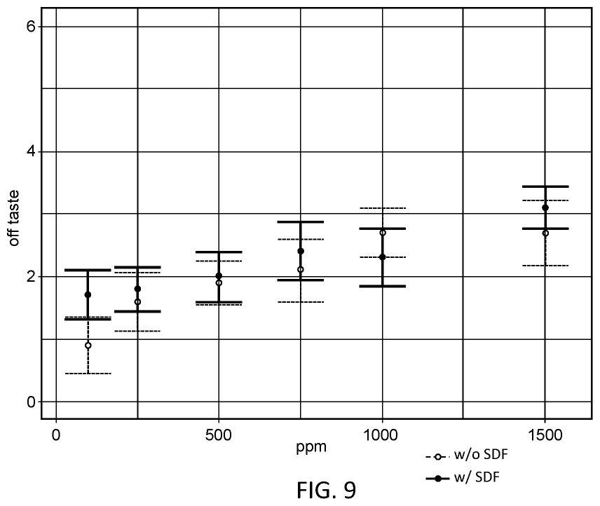

Data were also collected for off-taste (i.e., as compared to sucrose) on a 6-point scale. These are summarized in the Tables below and in FIGS. 8 and 9.

Without Soluble Dietary Fiber—Off-Taste

| | 100 | 250 | 500 | 750 | 1000 | 1500 |
|---|---|---|---|---|---|---|
| Off-Taste | ppm | ppm | ppm | ppm | ppm | ppm |
| not at all | 23 | 15 | 25 | 12 | 16 | 6 |
| perceptible | | | | | | |
| barely perceptible | 2 | 7 | 15 | 7 | 4 | 8 |
| very low intensity | 4 | 6 | 12 | 4 | 20 | 5 |
| moderately low | 1 | 2 | 7 | 7 | 14 | 9 |
| intensity | | | | | | |
| moderately high | 0 | 0 | 1 | 0 | 6 | 2 |
| intensity | | | | | | |
| very high intensity | 0 | 0 | 0 | 0 | 0 | 0 |
| mean | 0.93 | 1.60 | 1.85 | 2.10 | 2.73 | 2.70 |
| std dev | 1.20 | 1.25 | 1.38 | 1.35 | 1.49 | 1.39 |

With Soluble Dietary Fiber—Off-Taste

| | 100 | 250 | 500 | 750 | 1000 | 1500 |
|---|---|---|---|---|---|---|
| Off-Taste | ppm | ppm | ppm | ppm | ppm | ppm |
| not at all | 21 | 17 | 16 | 13 | 13 | 3 |
| perceptible | | | | | | |
| barely perceptible | 8 | 13 | 11 | 8 | 10 | 6 |
| very low intensity | 10 | 10 | 8 | 6 | 7 | 13 |
| moderately low | 3 | 2 | 6 | 10 | 9 | 17 |
| intensity | | | | | | |
| moderately high | 0 | 0 | 0 | 2 | 2 | 0 |
| intensity | | | | | | |
| very high intensity | 0 | 0 | 0 | 0 | 0 | 0 |
| mean | 1.67 | 1.76 | 1.98 | 2.41 | 2.29 | 3.10 |
| std dev | 1.26 | 1.14 | 1.25 | 1.45 | 1.49 | 1.02 |

Off-Taste Summary

| | | 100 | 250 | 500 | 750 | 1000 | 1500 |
|---|---|---|---|---|---|---|---|
| fiber | | ppm | ppm | ppm | ppm | ppm | ppm |
| Without SDF | mean | 0.9 | 1.6 | 1.9 | 2.1 | 2.7 | 2.7 |
| | variance | 1.4 | 1.6 | 1.9 | 1.8 | 2.2 | 1.9 |
| With SDF | mean | 1.7 | 1.8 | 2.0 | 2.4 | 2.3 | 3.1 |
| | variance | 1.6 | 1.3 | 1.6 | 2.1 | 2.2 | 1.0 |
| Student's t | | 2.50 | 0.56 | 0.47 | 0.92 | −1.46 | 1.33 |
| p-value | | 0.01 | 0.58 | 0.64 | 0.36 | 0.15 | 0.19 |

The combination of SSC stevia sweetener with the soluble dietary fiber was statistically significantly sweeter than the same concentration of SSC stevia sweetener without soluble dietary fiber at four of six concentrations evaluated. The mean increase in sweetness was 1.0 SEV. The calculated Beidler equation parameters were:

| parameter | With soluble dietary fiber | Without soluble dietary fiber |
|---|---|---|
| Rₘₐₓ | 10.8 | 10.3 |
| 1/K | 178 | 257 |

Thus, SSC stevia sweetener with soluble dietary fiber is predicted to have a slightly higher maximum sweetness and the increase in sweetness is quicker than SSC stevia sweetener without soluble dietary fiber.

Moreover, SSC stevia sweetener with soluble dietary fiber was statistically significantly higher in overall acceptance at 1000 ppm than SSC stevia sweetener without soluble dietary fiber.

SSC stevia sweetener with soluble dietary fiber was rated statistically significantly less like sucrose at 100 ppm and 250 ppm than SSC stevia sweetener without soluble dietary fiber. But SSC stevia sweetener with soluble dietary fiber was rated statistically significantly more like sucrose at 1000 ppm than SSC stevia sweetener without soluble dietary fiber. There was not a significant difference in overall acceptance at the other concentrations between SSC stevia sweetener with soluble dietary fiber and SSC stevia sweetener without soluble dietary fiber.

In summary, the combination of SSC stevia sweetener with 5% soluble dietary fiber increased the sweetness of the water solutions over SSC stevia sweetener alone. These data suggest that soluble dietary fiber and polydextrose can be used to amplify the sweetness of a sweetener such as a steviol glycoside, e.g., to provide perceivable sweetness even when the sweetener is present in a food or beverage product in an amount that itself does not provide perceptible sweetness.

### Example 2—Soluble Dietary Fiber and SSC and SSA Stevia Sweeteners

Sweetened tea can be intensely sweet, with products commonly formulated to be equivalent to about 10% sucrose in sweetness. For common commercial stevia products this level of sweetening is not achievable without significant defects in overall taste performance. Additionally, when sugar is removed from highly sweetened beverages there are reports of a reduced mouthfeel, which is perceived as a deviation from sugar-likeness. Here, the use of soluble dietary fiber to increase mouthfeel was investigated; its interaction with stevia sweeteners was also investigated.

Samples of 100, 250, 500, 750, 1000, and 1500 ppm of an SSC stevia sweetener or an SSA stevia sweetener with and without 5% PROMITOR® soluble dietary fiber (less than 2% mono- and disaccharides) in neutral pH water were evaluated for sweetness, liking, and off flavors by a general untrained panel. Additionally, stevia sweetener with increasing amounts of fiber were evaluated for overall sweetness and mouthfeel along with a full sugar control.

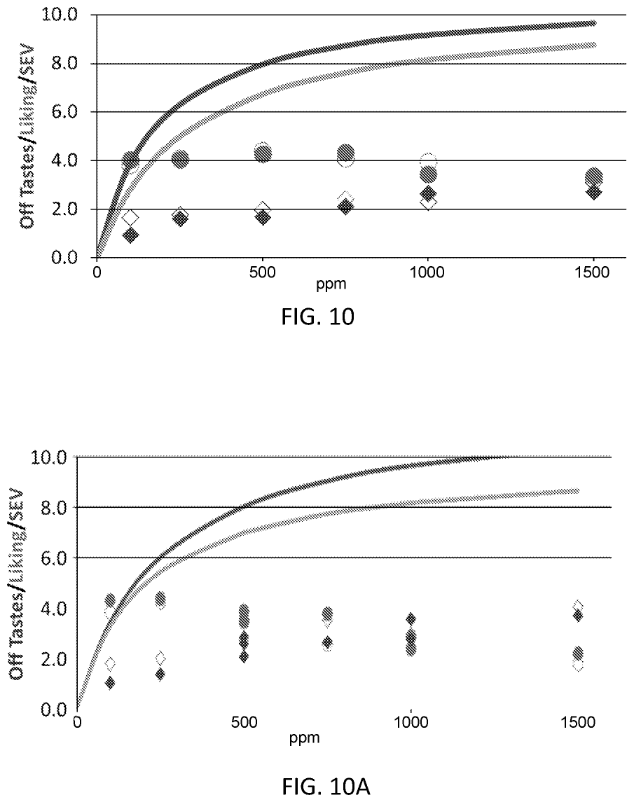

FIG. 10 presents the impact of soluble dietary fiber on sweetness, off-taste and overall liking for the SSC stevia sweetener, in which the darker line indicates SEV with soluble dietary fiber; the lighter line indicates SEV without soluble dietary fiber: hollow diamonds and filled diamonds indicate off-taste with and without soluble dietary fiber, respectively, and hollow circles and filled circles indicate overall liking with and without soluble dietary fiber, respectively. Liking scores of 4 or more and off-flavor scores of 2 or less are favorable.

FIG. 10A presents the impact of soluble dietary fiber on sweetness, off-taste and overall liking for the SSA stevia sweetener, in which the darker line indicates SEV with soluble dietary fiber; the lighter line indicates SEV without soluble dietary fiber: hollow diamonds and filled diamonds indicate off-taste with and without soluble dietary fiber, respectively, and hollow circles and filled circles indicate overall liking with and without soluble dietary fiber, respectively. Liking scores of 4 or more and off-flavor scores of 2 or less are favorable.

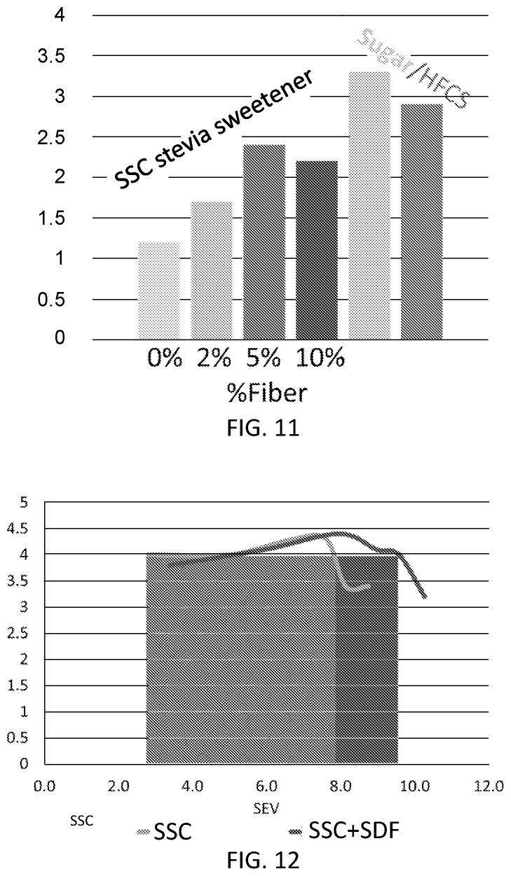

FIG. 11 presents a comparison of the impact of soluble dietary fiber on perceived thickness as compared to sugar and high fructose corn syrup (HCFS) at equivalent sweetness values. And FIG. 12 presents the impact of soluble dietary fiber on liking as a function of sweetness.

While soluble dietary fiber did not greatly impact the overall liking of the premium stevia blend at any given sweetener concentration, when perceived sweetness is accounted for the blend is acceptable up to about two additional sweetness units.

While sweetener selection depends on the exact flavor system and food matrix used several insights can be gained from studying simple water systems. In water typical stevia fails near 6 SEV, while premium stevia is liked at nearly 3 SEV. Thus, the use of soluble dietary fiber can extend the performance of stevia sweeteners to nearly 10 SEV by enhancement of sweet taste, and can provide mouthfeel.

### Example 3—Yogurt

In order to combat the obesity epidemic, high-intensity sweeteners are widely used for sugar reduction in various food applications. The present inventors have noted that, that particularly in long-shelf life yogurt, the ultra-high temperature (UHT) pasteurization process used during production can introduce harsh temperature treatment to the ingredients. Since long shelf-life yogurt undergoes not only UHT but also an additional pasteurization treatment (HTST), the effects of UHT/HTST pasteurization on sweeteners and fibers were assessed, especially with respect to fermentation time to target pH; pH values “pre-fermentation and post-UHT” and “post-fermentation and UHT/HTST”; and viscosity.

Long shelf life yogurt (control with sucrose, formulation with SSC stevia sweetener (including blend of rebaudioside A and rebaudioside B), and formulations with SSC stevia sweetener and PROMITOR® soluble dietary fiber (less than 2% mono- and disaccharides)) were produced using Microthermics UHT and HTST processing equipment, with tubular heating. The unit was equipped with an in-line GEA homogenizer, which ran upstream of the process. Batch size was 28 L and formulations were unflavored long shelf-life yogurt comprised of milk, texturizers (e.g. starch, pectin, and/or others), and sweetener, optionally with fiber. The table below shows amounts of sweetener (sucrose or SSC stevia sweetener) and soluble dietary fiber in various samples:

| Sample | Sucrose | SSC | SDF |
|---|---|---|---|
| control | 8.000 | 0 | 0 |
| 1 | 0 | 0.053 | 0 |
| 2 | 0 | 0.053 | 2.00 |
| 3 | 0 | 0.053 | 5.00 |

At 60° C., formulations were homogenized at 180 bars for stage 1, and 50 bars for stage 2 of the homogenizer. UHT treatment (133° C., 4-second hold) followed. Formulations were cooled to inoculation temperature (43° C.) and fermented to pH 4.60 (e.g., for approximately three hours, see below). Product was smoothed through a smoothing pump and HTST pasteurized at 75° C. for 30 seconds, then cooled, packaged and stored.

Fermentation time to target pH: Samples were cooled to inoculation temperature (43° C.) and fermented to pH 4.60 by storing the product in an incubator at 43° C. pH measurements were taken periodically until pH 4.60 was achieved. At this time, the product was removed from the incubator, sheared via a smoothing pump, and then pasteurized through HTST. Samples of each trial containing fiber were analyzed for fiber (AOAC 2011.25).

All yogurt trials achieved 4.60 pH within 3-3.5 hours of fermentation with mild yogurt culture (which in addition to yogurt culture (Lactobacillus bulgaricus and Streptococcus thermophiles), contained the probiotics: Lactobacillus acidophilus, Bifidobacterium and L. casei). Fiber analyses indicated that for the trials containing soluble dietary fiber, there was no fiber loss in the finished product. The table below illustrates the time and pH achieved, per trial.

Fermentation (Mild culture for yogurt)
Lactobacillus bulgaricus, Streptococcus thermophilus and the
probiotics: Lactobacillus acidophilus, Bifidobacterium and L. casei

| | | Incubation | |
|---|---|---|---|
| | | time | |
| Trial | Key Variables | (hr:min) | pH |
| Control | 8% sucrose | 3:15 | 4.65 |
| 1 | 530 ppm SSC | 3:27 | 4.64 |
| 2 | 530 ppm SSC + 2% SDF | 3:05 | 4.60 |
| 3 | 530 ppm SSC + 5% SDF | 3:00 | 4.66 |

pH “pre-fermentation and post-UHT” and “post-fermentation and UHT/HTST”: pH was measured after UHT treatment and before fermentation, and again post-fermentation, and post UHT/HTST. For all trials, pH values did not change significantly when soluble dietary fiber was present, as shown in the table below.

| | | | pH |
|---|---|---|---|
| | | pH | (Fermented, |
| | | (Fermented, | UHT & HTST |
| Trial | Key Variables | UHT) | Pasteurized) |
| Control | 8% sucrose | 4.32 | 4.40 |
| 1 | 530 ppm SSC | 4.36 | 4.40 |
| 2 | 530 ppm SSC + 2% | 4.35 | 4.37 |
| | SDF | | |
| 3 | 530 ppm SSC + 5% | 4.37 | 4.38 |
| | SDF | | |

Viscosity: The viscosity for sucrose-containing control was 475 cP. For the stevia-containing samples 1-3, the range was 530-577 Cp. These values are understood to be similar to one another. Data pare provided in Table 4 for the finished, UHT/HTST-pasteurized materials.

| | | Viscosity |
|---|---|---|
| Trial | Key Variables | (cP) |
| Control | 8% sucrose | 475 |
| 1 | 530 ppm SSC | 530 |
| 2 | 530 ppm SSC + 2% SDF | 552 |
| 3 | 530 ppm SSC + 5% SDF | 577 |

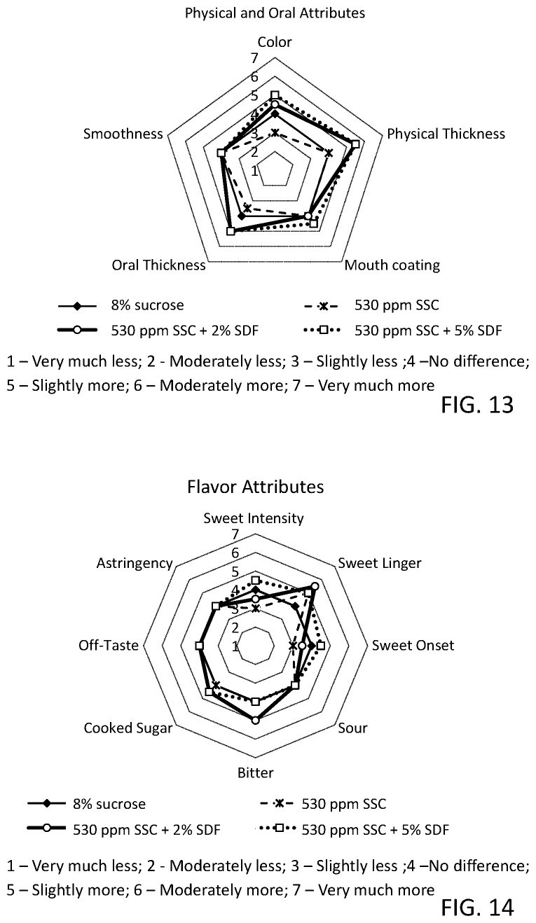

Sensory FIGS. 13 and 14 illustrate the physical and oral attributes, and flavor attributes, respectively, as determined by a highly trained descriptive panel.

All samples were determined to be equivalent in smoothness by the descriptive panel. Physical thickness was ranked in the following order: Control=Trial 1<Trial 2=Trial 3. Oral Thickness was ranked as follows: Trial 1<Control<Trial 2=Trial 3.

Sweetness Intensity was ranked as follows: Trial 1<Control<Trial 2<Trial 3. Notably, the sweetness intensity data demonstrate surprising and unexpected results: The use of stevia sweetener without soluble dietary fiber provided lower sweetness intensity than the sucrose control. In contrast, the use of 2% soluble dietary fiber in combination with the stevia sweetener provided an increased sweetness intensity as compared to the sucrose control. This effect was dose-dependent, as the use of 5% soluble dietary fiber provided even higher sweetness intensity than the 2% trial. This result would not have been expected based on the state of the art.

Thus, long-shelf life yogurt with no sugar added vas successfully produced using stevia sweetener alone or stevia sweetener and soluble dietary fiber in combination. Notably, there was no significant impact of replacement of sucrose with stevia sweetener or the addition of soluble dietary corn fiber on the manufacturing process, including the time required to achieve pH 4.60 by fermentation with yogurt culture. The pH was stable throughout the process, as shown by the fact that pH post-fermentation and UHT was unchanged after the second heat treatment (HTST). Measured viscosities for stevia sweetener-containing trial materials was slightly higher than sucrose containing control. But surprisingly and unexpectedly, it was observed that the combination of stevia sweetener with soluble dietary fiber progressively increased sweetness intensity. Notably, this effect was perceived even in the complexly-flavored context of yogurt.

### Example 4—Fermented Milk Beverage

Experiments were performed to demonstrate the behavior of stevia sweeteners SSA, SSB and SSC combination with soluble dietary fiber (<2% mono- and disaccharides) or polydextrose (89:10 dextrose:sorbitol feed) in acidic water.

Samples were prepared in the table below. All samples included 0.1 wt % lactic acid to provide a pH of about 3.6.

| Sample name | Sucrose | Sweetener | Fiber |
|---|---|---|---|
| Sucrose | 11% | None | None |
| SSA | 0% | SSA 600 ppm | None |
| SSA + SDF | 0% | | Promitor 85 10% |
| SSA + Polydextrose | 0% | | Sta-Lite III 10% |
| SSA + Sucrose | 3% | SSA 550 ppm | None |
| SSA + Sucrose + SDF | 3% | | Promitor 85 10% |
| SSA + Sucrose + Polydextrose | 3% | | Sta-Lite III 10% |
| SSB | 0% | SSB 710 ppm | None |
| SSB + SDF | 0% | | Promitor 85 10% |
| SSB + Polydextrose | 0% | | Sta-Lite III 10% |
| SSB + Sucrose | 3% | SSB 600 ppm | None |
| SSB + Sucrose + SDF | 3% | | Promitor 85 10% |
| SSB + Sucrose + Polydextrose | 3% | | Sta-Lite III 10% |
| SSC | 0% | SSC 680 ppm | None |
| SSC + SDF | 0% | | Promitor 85 10% |
| SSC + Polydextrose | 0% | | Sta-Lite III 10% |
| SSC + Sucrose | 3% | SSC 550 ppm | None |
| SSC + Sucrose + SDF | 3% | | Promitor 85 10% |
| SSC + Sucrose + Polydextrose | 3% | | Sta-Lite III 10% |

Sweetness was assessed by a highly trained descriptive panel, initial and maximum sweetness data were collected for each of the 19 samples using a randomized order of presentation produced by the data collection software CompuSense®. Each sample was evaluated in duplicate, presented in 2 oz. lidded plastic cups labelled with a randomized 3-digit code and tested using a standardized amount. Before each day of evaluation (one day per replication) the panel calibrated their perception with sucrose solutions varying from 3 to 13%. The references were available for comparison with the samples but cleansing with crackers and water and also a waiting period were required between each tasting. The statistical analysis was performed with a mixed models ANOVA with panelists and replications as blocks. The multiple comparison procedures were accomplished with Fisher's LSD post hoc test. All analyses were conducted at a 0.05 alpha level.

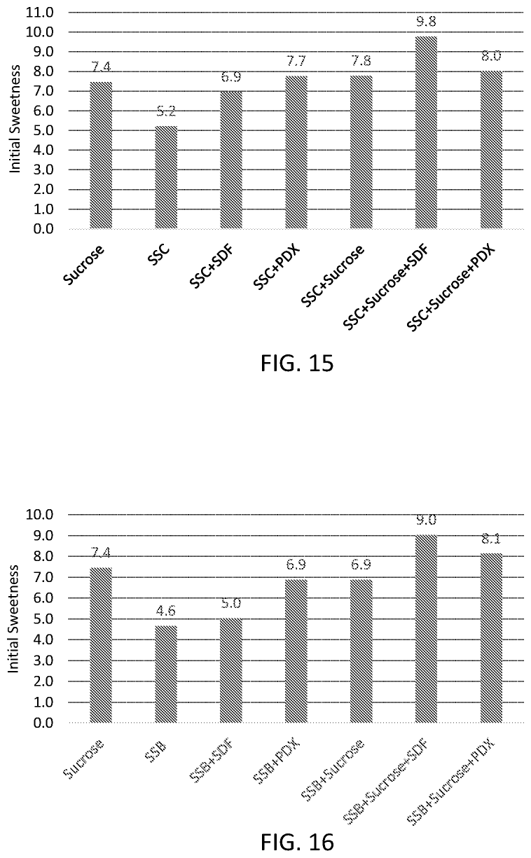

FIGS. 15-17 present initial sweetness data for SSC stevia sweetener, SSB stevia sweetener, and SSA stevia sweetener respectively.

FIG. 15 demonstrates that each of 10% soluble dietary fiber and 10% polydextrose enhanced the initial sweetness of 680 ppm SSC stevia sweetener alone by 1.7 SEV and 2.5 SEV respectively, providing an initial sweetness very close to the 7.4 SEV value of 11% sucrose. For the mixture of 550 ppm SSC stevia sweetener and 3% sucrose, 10% soluble dietary fiber significantly enhanced the initial sweetness by 2 SEV; in contrast, almost no enhancement by 10% polydextrose was observed.

FIG. 16 demonstrates that 10% polydextrose enhanced the initial sweetness of 710 ppm SSB stevia sweetener by 2.3 SEV, providing an initial sweetness very close to the 7.4 SEV value for 11% sucrose. However, almost no enhancement by 10% soluble dietary fiber was observed. For the mixture of 600 ppm SSB stevia sweetener and 3% sucrose, both 10% soluble dietary fiber and 10% polydextrose were shown to significantly enhance initial sweetness, by 1.9 SEV and 1.2 SEV respectively.

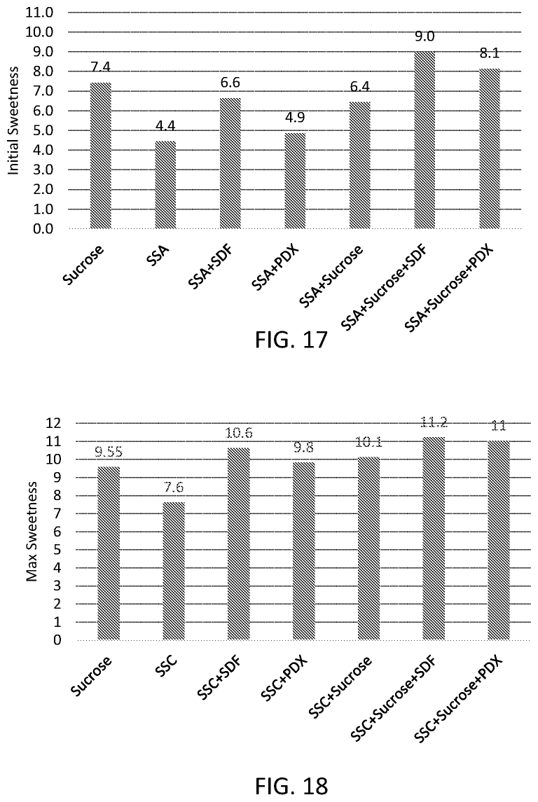

FIG. 17 demonstrates that 10% soluble dietary fiber can significantly enhance the initial sweetness of 600 ppm SSA by 1.3 SEV, whereas almost no enhancement by 10% polydextrose was observed. The same trend was observed for the mixture of 550 ppm SSA stevia sweetener and 3% sucrose-10% soluble dietary fiber enhanced the initial sweetness by 1.5 SEV, while only about 0.8 SEV enhancement was observed for 10% polydextrose.

Thus, FIGS. 15-17 demonstrate that 10% soluble dietary fiber can significantly enhance the initial sweetness of three sweeteners and their mixtures with 3% sucrose to different extents, except for 710 ppm SSB stevia sweetener in the absence of soluble dietary fiber. 10% polydextrose was shown to significantly enhance the initial sweetness of 710 ppm SSB stevia sweetener, the mixture of 600 ppm SSB stevia sweetener and 3% sucrose, and 680 ppm SSA stevia sweetener to different extents. However, little influence of 10% polydextrose was observed for SSA samples and for the mixture of 550 ppm SSC and 3% sucrose.

FIGS. 18-20 present maximum sweetness data for SSC stevia sweetener, SSB stevia sweetener, and SWEETESSE® 97 stevia sweetener respectively.

FIG. 18 demonstrates that maximum sweetness of 680 ppm SSC stevia sweetener alone was only 7.6 SEV in acidic water, about 2 SEV lower than that of 11% sucrose in acidic water. 10% soluble dietary fiber enhanced the maximum sweetness by 3 SEV and 10% polydextrose enhanced the maximum sweetness by 2.2 SEV, each providing sweetness very close to that of 11% sucrose. Enhancement of sweetness by both soluble dietary fiber and polydextrose by about 1 SEV was also observed for the samples containing 550 ppm SSC stevia sweetener and 3% sucrose.

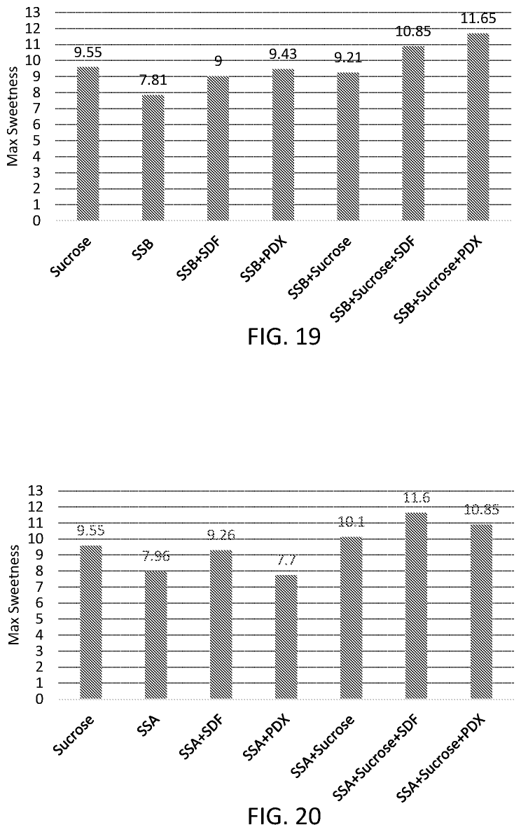

FIG. 19 demonstrates that sweetness of 710 ppm SSB stevia sweetener alone was only 7.8 SEV in acidic water, about 1.8 SEV lower than that of 11% sucrose in acidic water. 10% soluble dietary fiber enhanced the maximum sweetness by 1.2 SEV and 10% polydextrose enhanced the maximum sweetness by 1.6 SEV, each providing sweetness very close to that of 11% sucrose. Enhancement of sweetness by 10% soluble dietary fiber and 10% polydextrose was also observed for the samples containing 600 ppm SSB stevia sweetener and 3% sucrose, by 1.6 SEV and 2.4 SEV, respectively.

FIG. 20 demonstrates that maximum sweetness of 600 ppm SSA stevia sweetener was only 8.0 in acidic water, about 1.5 SEV lower than 11% sucrose in acidic water. However, 10% soluble dietary fiber enhanced the maximum sweetness by 1.3 SEV, providing sweetness very close to that of 11% sucrose. However, 10% polydextrose did not provide significant enhancement of maximum sweetness. Enhancement of sweetness by 10% soluble dietary fiber for samples containing 550 ppm SSA 97 stevia sweetener and 3% sucrose was 1.5 SEV, while only slight enhancement by 10% polydextrose was observed.

Thus, FIGS. 18-20 demonstrate that soluble dietary fiber can enhance the maximum sweetness for all three sweeteners and mixtures of all three sweeteners with 3% sucrose, to different extents. Polydextrose can enhance the maximum sweetness of SSC stevia sweetener and SSB stevia sweetener as well as their mixtures with 3% sucrose.

These data suggest that soluble dietary fiber and polydextrose can be used to amplify the sweetness of a sweetener such as a steviol glycoside, e.g., to provide perceivable sweetness even when the sweetener is present in a food or beverage product in an amount that itself does not provide perceptible sweetness.

### Example 4—Flavor Enhancement by Soluble Dietary Fiber

Stock solutions of benzaldehyde, ethyl butyrate, and D-limonene were prepared in ethanol (190 proof) at ambient temperature:

| | | | | Mass (g) | | |
|---|---|---|---|---|---|---|
| | | | | Sol'n | Sol'n | Sol'n |
| Material | Vendor | Grade/Purity | Lot # | 1 | 2 | 3 |
| Benzaldehyde | Sigma-Aldrich | FG, FCC, >98% | MKCJ2083 | 0.4 | | |
| Ethyl Butyrate | Sigma-Aldrich | FCC, FG, >98% | MKCG4866 | | 2.4 | |
| Limonene | Spectrum | FG, 95-97.5% | 2IC0357 | | | 7.2 |
| Ethanol, 95% | Decon Lab. | USP, 190 proof | A02091902M | 39.6 | 37.6 | 32.8 |
| | | | Total mass (g) | 40 | 40 | 40 |

Flavored water beverages were prepared using flavor stock solutions, 0.15% citric acid, 0.04% sodium citrate, sweetener (0.020-5.0%), and deionized water. Sweetener levels were adjusted to equivalent levels in acidified water. Details of a control beverage and eight trial beverages as prepared for each flavor are provided in the table below:

| | Control | Trial1 | Trial 2 | Trial 3 | Trial 4 | Trial 5 | Trial 6 | Trial 7 | Trial 8 |
|---|---|---|---|---|---|---|---|---|---|
| Ingredient | (%) | (%) | (%) | (%) | (%) | (%) | (%) | (%) | (%) |
| Distilled Water | 94.71 | 99.71 | 99.688 | 99.688 | 99.69 | 99.684 | 99.678 | 95.688 | 95.688 |
| Sugar, Granulated | 5 | 0 | 0 | 0 | 0 | 0 | 0 | 0 | 0 |
| Citric acid | 0.15 | 0.15 | 0.15 | 0.15 | 0.15 | 0.15 | 0.15 | 0.15 | 0.15 |
| Sodium | 0.04 | 0.04 | 0.04 | 0.04 | 0.04 | 0.04 | 0.04 | 0.04 | 0.04 |
| citrate | | | | | | | | | |
| SSA | 0 | 0 | 0.022 | 0 | 0 | 0 | 0 | 0 | 0 |
| SSC | 0 | 0 | 0 | 0.022 | 0 | 0 | 0.022 | 0.022 | 0.022 |
| SSD | 0 | 0 | 0 | 0 | 0.02 | 0 | 0 | 0 | 0 |
| SSB | 0 | 0 | 0 | 0 | 0 | 0.026 | 0 | 0 | 0 |
| Monk Fruit extract | 0 | 0 | 0 | 0 | 0 | 0 | 0.01 | 0 | 0 |
| SDF | 0 | 0 | 0 | 0 | 0 | 0 | 0 | 4 | 0 |
| Polydextrose | 0 | 0 | 0 | 0 | 0 | 0 | 0 | 0 | 4 |
| Flavor in Ethanol * | 0.1 | 0.1 | 0.1 | 0.1 | 0.1 | 0.1 | 0.1 | 0.1 | 0.1 |
| TOTAL | 100 | 100 | 100 | 100 | 100 | 100 | 100 | 100 | 100 |

Model flavored water beverages were tested in round table analysis by 5 panelists experienced in tasting food and beverages. Beverages were tasted at ambient temperature. Water and unsalted crackers were available for the panelists to clear their palates. A modified quantitative descriptive analysis was used. The panelists tasted the samples and developed attributes that described the taste and flavor of the sample. Attributes were assessed by the panelists on a 5-point scale. Consensus ratings were recorded. Ratings were given based on attributes chosen by the panelists on a 5 point scale (0=not perceived, 1=very low, 2=low, 3=medium, 4=high, 5=very high). Data are provided in the tables below:

LIMONENE (citrus): Soluble dietary fiber altered the perception of sweet, sour, lemon, and peel. Poiydextrose altered perception of citrus, lemon, and astringency.

| product | lime | sweet | sour | orange | lemon | citrus | peel | astringent | lingering.peel |
|---|---|---|---|---|---|---|---|---|---|
| Sucrose | 1 | 3 | 2 | 1 | 2 | 3 | 2 | 0 | 0 |
| SSD | 0 | 4 | 2 | 3 | 0 | 3 | 1 | 0 | 0 |
| SSC | 0 | 3 | 3 | 0 | 3 | 3 | 2 | 1 | 0 |
| SSC + Monk Fruit | 0 | 3 | 3 | 0 | 0 | 2 | 1 | 0 | 0 |
| SSA | 0 | 3 | 3 | 0 | 0 | 3 | 2 | 1 | 0 |
| SSB | 0 | 3 | 3 | 0 | 0 | 3 | 2 | 1 | 1 |
| SSC + PDX | 0 | 3 | 3 | 0 | 0 | 2 | 2 | 0 | 0 |
| SSC + SDF | 0 | 2 | 4 | 0 | 0 | 3 | 1 | 1 | 0 |
| Limonene only | 0 | 0 | 4 | 0 | 0 | 2 | 4 | 3 | 3 |

BENZALDEHYDE (cherry): Soluble dietary fiber altered sour, sweetness, citrus, chemical off-flavor, bitter linger, and corn-syrup off-note. Polydextrose altered sour, citrus, chemical off-flavor, and cardboard off-note.

| | black | candy | | | | | | | | sweet | bitter | | corn | | |
|---|---|---|---|---|---|---|---|---|---|---|---|---|---|---|---|
| product | cherry | cherry | sour | sweet | bitter | citrus | apple | chemic'l | astnig'nt | linger | linger | almond | syrup | cardb'd | metallic |
| control | 3 | 0 | 4 | 2 | 1 | 1 | 0 | 0 | 0 | 0 | 0 | 0 | 0 | 0 | 0 |
| SSD | 2 | 0 | 3 | 3 | 0 | 0 | 1 | 0 | 0 | 0 | 0 | 0 | 0 | 0 | 0 |
| SSC | 3 | 0 | 5 | 2 | 1 | 2 | 0 | 1 | 2 | 1 | 0 | 0 | 0 | 0 | 0 |
| SSB | 2 | 0 | 4 | 2 | 3 | 1 | 0 | 0 | 1 | 1 | 2 | 1 | 0 | 0 | 0 |
| SSA | 1.5 | 0 | 3 | 2 | 2 | 1 | 1 | 0 | 2 | 1 | 2 | 1 | 0 | 0 | 0 |
| Monkfruit | 0 | 3 | 3 | 4 | 1 | 1 | 0 | 0 | 1 | 1 | 0 | 0 | 0 | 0 | 0 |
| SSC + | 2 | 0 | 3 | 2.5 | 1 | 1 | 0 | 0 | 2 | 1 | 1 | 0 | 2 | 0 | 0 |
| SDF | | | | | | | | | | | | | | | |
| SSC + | 3 | 0 | 2 | 2 | 1 | 0 | 0 | 0 | 2 | 1 | 0 | 0 | 0 | 2 | 0 |
| PDX | | | | | | | | | | | | | | | |
| aldehyde | 1 | 0 | 5 | 0 | 3 | 0 | 2 | 1 | 0 | 0 | 0 | 0 | 0 | 0 | 3 |
| only | | | | | | | | | | | | | | | |

ETHYL BUTYRATE (grape): Soluble dietary fiber altered sweetness, sour, floral, and grape flavor description. Polydextrose altered grape level, grape flavor description, sweetness, sour, and floral.

| | grape | sweet | sour | floral | metalic | apple | Bitter | astringent | character |
|---|---|---|---|---|---|---|---|---|---|
| Control | 3 | 3 | 2 | 0 | 1 | 1 | 0 | | candy grape |
| SSD | 2 | 3 | 3 | 2 | | | 0 | | jam grape |
| SSC | 2 | 2 | 3.5 | 2 | 0 | 0 | 0 | | unriped |
| SSC + | 3 | 4 | | 3 | | | 1 | | candy, |
| Monk Fruit | | | | | | | | | unripe |
| SSA | 3.5 | 2 | 3 | | | 2 | | | unriped |
| SSB | 2.5 | 3 | 3 | 2 | | | | 1 | candy |
| SSC + SDF | 2 | 3 | 1 | | | | | | jam |
| SSC + PDX | 3 | 3 | 2 | 1 | | | | 0 | jammy and |
| | | | | | | | | | acandy |
| Flavor only | 2 | 0 | 4 | | | | 2 | 1 | unriped |
| | | | | | | | | | green |

### Example 5—Determination of Molecular Weight of Soluble Dietary Fiber

Samples are dissolved in GPC eluent (aqueous 0.1 NNaNO₃, 1 mM NaN₃, 0.4% methanol flow rate marker) at 50 mg in 10 g total eluent at room temperature with stirring. Solutions are filtered through 0.45 Lim nylon syringe filters directly into GPC autosampler vials. All samples are injected in duplicate with 50 μL injections. GPO analysis was performed at 70° C. on two Waters Ultrahydrogei 250 Å and 150 Å, 7.8×300 mm columns plus 7.8×50 mm guard at 1.3 mL/min with aqueous 1 N NaNO₃, 1 mM NaN₃. Third order regression fit is applied to flow marker corrected retention time versus log M from a series of narrow standard pullulans ranging from 180 to 404,000 Da Mp. Results are reported as pullulan equivalent molecular weight.

Additional aspects of the disclosure are exemplified by the following enumerated embodiments, which may be combined in any number and in any combination not technically or logically inconsistent.

Embodiment 1. A sweet-taste enhancing composition comprising
at least one sweetener; and
at least 1 wt % of a soluble oligomeric component selected from soluble dietary fiber and polydextrose, or a combination thereof,
   in a food or beverage product,
wherein the soluble oligomeric component is present in an amount that enhances the perceived sweet taste of the sweetened food or beverage product by an amount that is greater than a sweet taste due to the soluble oligomeric component itself.
   Embodiment 2. A sweetness-enhancing composition comprising
at least one sweetener; and
at least 1 wt % of a soluble oligomeric component selected from soluble dietary fiber and polydextrose, or a combination thereof,
   in a food or beverage product,
wherein the soluble oligomeric component is present in an amount that enhances the perceived sweetness of the sweetened food or beverage product by an amount that is greater than a sweetness due to the soluble oligomeric component itself.
   Embodiment 3. A flavor-modifying composition comprising
at least one sweetener; and
at least 1 wt % of a soluble oligomeric component selected from soluble dietary fiber and polydextrose, or a combination thereof,
   in a food or beverage product,
wherein the soluble oligomeric component is present in an amount that alters (e.g., enhances or reduces) a flavor of the food or beverage product by an amount that is greater than any alteration due to a flavor of the soluble oligomeric component itself.
   Embodiment 4. A flavor-enhancing composition comprising
at least one sweetener; and
at least 1 wt % of a soluble oligomeric component selected from soluble dietary fiber and polydextrose, or a combination thereof,
   in a food or beverage product,
wherein the soluble oligomeric component is present in an amount that enhances a flavor of the food or beverage product by an amount that is greater than any alteration due to a flavor of the soluble oligomeric component itself.
   Embodiment 5. A sweetened food or beverage product comprising
at least one sweetener; and
at least 1 wt % of a soluble oligomeric component selected from soluble dietary fiber and polydextrose, or a combination thereof,
   wherein the soluble oligomeric component is present in an amount that enhances the perceived sweetness of the sweetened food or beverage product by an amount that is greater than a sweetness due to the soluble oligomeric component itself.
   Embodiment 6. A method for enhancing the sweetness of a food or beverage product containing at least one sweetener, the method comprising including at least 1 wt % of soluble oligomeric component selected from soluble dietary fiber and polydextrose, or a combination thereof in the food or beverage product, the enhancement being by an amount that is greater than a sweetness due to the soluble oligomeric component itself.
   Embodiment 7. A method of sweet taste enhancement, the method comprising including in a food or beverage containing at least one sweetener at least 1 wt % of soluble oligomeric component selected from soluble dietary fiber and polydextrose, or a combination thereof, the enhancement being by an amount that is greater than a sweet taste due to the soluble oligomeric component itself.
   Embodiment 8. A method of sweetness enhancement, the method comprising including in a food or beverage containing at least one sweetener at least 1 wt % of soluble oligomeric component selected from soluble dietary fiber and polydextrose, or a combination thereof, the enhancement being by an amount that is greater than a sweetness due to the soluble oligomeric component itself.
   Embodiment 9. A method of flavor modification, the method comprising including in a food or beverage containing at least one sweetener at least 1 wt % of soluble oligomeric component selected from soluble dietary fiber and polydextrose, or a combination thereof, the soluble oligomeric component being included in an amount that alters (e.g., enhances or reduces) a flavor of the food or beverage product by an amount that is greater than any alteration due to a flavor of the soluble oligomeric component itself.
   Embodiment 10. A method of flavor enhancement, the method comprising including in a food or beverage containing at least one sweetener at least 1 wt % of soluble oligomeric component selected from soluble dietary fiber and polydextrose, or a combination thereof, the soluble oligomeric component being included in an amount that enhances a flavor of the food or beverage product by an amount that is greater than any alteration due to a flavor of the soluble oligomeric component itself.
   Embodiment 11. The method, composition or food or beverage product of any of embodiments 1-10, wherein the soluble oligomeric component does not provide substantial sweetness (e.g., no more than 0.1 SEV).
   Embodiment 12. The method, composition or food or beverage product of any of embodiments 1-11, wherein the enhancement in sweetness is at least 0.5 SEV, e.g., in the range of 0.5-3 SEV or 0.5-2.5 SEV.
   Embodiment 13. The method, composition or food or beverage product of any of embodiments 1-11, wherein the enhancement in sweetness is at least 1 SEV, e.g., in the range of 1-3.5 SEV or 1-3 SEV.
   Embodiment 14. The method, composition or food or beverage product of any of embodiments 1-11, wherein the enhancement in sweetness is at least 1.5 SEV, e.g., in the range of 1.5-3.5 SEV, or 1.5-3 SEV.
   Embodiment 15. The method, composition or food or beverage product of any of embodiments 1-14, wherein the at least one sweetener is at least one steviol glycoside.
   Embodiment 16. The method, composition or food or beverage product of embodiment 15, wherein the at least one steviol glycoside comprises one or more of stevioside and Rebaudiosides A-F, J, I, M, N and O.
   Embodiment 17. The method, composition or food or beverage product of embodiment 15, wherein the at least one steviol glycoside comprises stevioside, Rebaudioside A, Rebaudioside B and/or Rebaudioside M.
   Embodiment 18. The method, composition or food or beverage product of embodiment 15, wherein the at least one steviol glycoside comprises Rebaudioside A.
   Embodiment 19. The method, composition or food or beverage product of embodiment 15, wherein the at least one steviol glycoside comprises Rebaudioside M.
   Embodiment 20. The method, composition or food or beverage product of embodiment 15, wherein the at least one rebaudioside comprises a combination of Rebaudioside A and Rebaudioside B.
   Embodiment 21. The method, composition or food or beverage product of embodiment 15, wherein the at least one rebaudioside comprises a combination of stevioside and one or more of Rebaudioside A, Rebaudioside B and Rebaudioside D.
   Embodiment 22. The method, composition or food or beverage product of any of embodiments 15-21, wherein the at least one steviol glycoside is present in the food or beverage product in an amount of at least 200 ppm.
   Embodiment 23. The method, composition or food or beverage product of any of embodiments 15-21, wherein the at least one steviol glycoside is present in the food or beverage product in an amount of at least 400 ppm.
   Embodiment 24. The method, composition or food or beverage product of any of embodiments 15-21, wherein the at least one steviol glycoside is present in the food or beverage product in an amount of at least 600 ppm.
   Embodiment 25. The method, composition or food or beverage product of any of embodiments 15-21, wherein the at least one steviol glycoside is present in the food or beverage product in an amount in the range of 100-3000 ppm, e.g., 200-3000 ppm, 400-3000 ppm, or 600-3000 ppm.
   Embodiment 26. The method, composition or food or beverage product of any of embodiments 15-21, wherein the at least one steviol glycoside is present in the food or beverage product in an amount in the range of 100-2000 ppm, e.g., 200-2000 ppm, 400-2000 ppm, or 600-2000 ppm.
   Embodiment 27. The method, composition or food or beverage product of any of embodiments 15-21, wherein the at least one steviol glycoside is present in the food or beverage product in an amount in the range of 100-1500 ppm, e.g., 200-1500 ppm, 400-1500 ppm, or 600-1500 ppm.
   Embodiment 28. The method, composition or food or beverage product of any of embodiments 15-21, wherein the at least one steviol glycoside is present in the food or beverage product in an amount in the range of 100-1000 ppm, e.g., 200-1000 ppm, 400-1000 ppm, or 600-1000 ppm.
   Embodiment 29. The method, composition or food or beverage product of any of embodiments 15-21, wherein the at least one steviol glycoside is present in the food or beverage product in an amount less than an amount that provides 1.5 SEV to the food or beverage product, e.g., no more than 23, or no more than ⅓ of the amount that provides 1.5 SEV to the food or beverage product (i.e., in the absence of the soluble oligomeric component).
   Embodiment 30. The method, composition or food or beverage product of any of embodiments 15-21 wherein the at least one steviol glycoside is present in the food or beverage in an amount such that it does not provide perceptible sweetness to the food or beverage product (i.e., in the absence of the soluble oligomeric component).
   Embodiment 31. The method, composition or food or beverage product of embodiment 29 or claim 30, wherein the sweetness enhancement is such that the steviol glycoside and soluble oligomeric component together provide at least 1.5 SEV to the food or beverage product, e.g., at least 2.0 SEV, at least 2.5 SEV, or even at least 3.0 SEV.
   Embodiment 32. The method, composition or food or beverage product of any of embodiments 29-31, wherein the soluble oligomeric component is present in an amount less than an amount of the soluble oligomeric component that provides 1.5 SEV to the food or beverage product in the absence of the steviol glycoside, e.g., no more than ⅔ of amount, or no more than 113 of that amount, or no more than 1/10 of that amount, or no more than 1/15 of that amount.
   Embodiment 33. The method, composition or food or beverage product of any of embodiments 15-32, wherein the food or beverage product does not include a sweetening sugar selected from sucrose, fructose, dextrose and xylose in an amount that provides more than 1 SEV, e.g., more than 0.5 SEV or more than 0.2 SEV, to the food or beverage product.
   Embodiment 34. The method, composition or food or beverage product of any of embodiments 15-32, wherein the food or beverage product includes no more than 5 wt % of sweetening sugar selected from sucrose, fructose, dextrose and xylose, e.g., no more than 2 wt % or no more than 1 wt %.
   Embodiment 35. The method, composition or food or beverage product of any of embodiments 15-32, wherein the food or beverage product includes in the range of 1-6 wt % of sweetening sugar selected from sucrose, fructose, dextrose and xylose, e.g., 2-6 wt %.
   Embodiment 36. The method, composition or food or beverage product of any of embodiments 1-35, wherein the at least one sweetener comprises at least one high-intensity sweetener.
   Embodiment 37. The method, composition or food or beverage product of any of embodiments 1-35, wherein the at least one sweetener comprises at least one high-intensity sweetener selected from acesulfame K, alitame, aspartame, a glucosylated steviol glycoside, N—[N-[3-(3-hydroxy-4-methoxyphenyl)propyl]-L-α-aspartyl]-L-phenylalanine 1-methyl ester, N—[N-[3-(3-hydroxy-4-methoxyphenyl)-3-methylbutyl]-L-α-aspartyl]-L-phenylalanine 1-methyl ester, N—[N-[3-(3-methoxy-4-hydroxyphenyl)propyl]-L-α-aspartyl]-L-phenylalanine 1-methyl ester, neohesperidin dihydrochalcone, neotame, sucralose and salts and/or solvates thereof.
   Embodiment 38. The method, composition or food or beverage product of any of embodiments 36 and 37 wherein the at least one high-intensity sweetener is present in the food or beverage in an amount such that it provides no more than 1.5 SEV to the food or beverage product, e.g., such that it provides no more than 1 SEV, or no more than 0.5 SEV to the food or beverage product (i.e., in the absence of the soluble oligomeric component).
   Embodiment 39. The method, composition or food or beverage product of any of embodiments 36 and 37 wherein the at least one high-intensity sweetener is present in the food or beverage in an amount such that it does not provide perceptible sweetness to the food or beverage product (i.e., in the absence of the soluble oligomeric component).
   Embodiment 40. The method, composition or food or beverage product of embodiment 38 or embodiment 39, wherein the sweetness enhancement is such that the at least one high-intensity sweetener and the soluble oligomeric component together provide at least 1.5 SEV to the food or beverage product, e.g., at least 2.0 SEV, at least 2.5 SEV, or even at least 3.0 SEV.
   Embodiment 41. The method, composition or food or beverage product of any of embodiments 38-40, wherein the soluble oligomeric component is present in an amount less than an amount of the soluble oligomeric component that provides 1.5 SEV to the food or beverage product in the absence of the high-intensity sweetener, e.g., no more than ⅔ of amount, or no more than 113 of that amount, or no more than 1/10 of that amount, or no more than 1/15 of that amount.
   Embodiment 42 The method, composition or food or beverage product of any of embodiments 1-41, wherein the at least one sweetener comprises at least one natural high-intensity sweetener.
   Embodiment 43. The method, composition or food or beverage product of any of embodiments 1-41, wherein the at least one sweetener comprises at least one natural high-intensity sweetener selected from abrusoside A, baiyunoside, brazzein, curculin, cyclocarioside 1, glycyphyllin, glycyrrhizic acid, hernandulcin, a monk fruit extract, mabinlin, monatin, monellin, mukurozioside, osiadin, periandrins, phlomisosides, phloridzin, phyllodulcin, polypodoside A, pterocaryoside A, pterocaryoside B, rubusoside, thaumatin and trilobatin, and salts and/or solvates thereof.
   Embodiment 44. The method, composition or food or beverage product of any of embodiments 42 and 43 wherein the at least one natural high-intensity sweetener is present in the food or beverage in an amount such that it provides no more than 1.5 SEV to the food or beverage product, e.g., such that it provides no more than 1 SEV, or no more than 0.5 SEV to the food or beverage product (i.e., in the absence of the soluble oligomeric component).
   Embodiment 45. The method, composition or food or beverage product of any of embodiments 42 and 43 wherein the at least one natural high-intensity sweetener is present in the food or beverage in an amount such that it does not provide perceptible sweetness to the food or beverage product (i.e., in the absence of the soluble oligomeric component).
   Embodiment 46. The method, composition or food or beverage product of embodiment 44 or 45, wherein the sweetness enhancement is such that the at least one natural high-intensity sweetener and the soluble oligomeric component together provide at least 1.5 SEV to the food or beverage product, e.g., at least 2.0 SEV, at least 2.5 SEV, or even at least 3.0 SEV.
   Embodiment 47. The method, composition or food or beverage product of any of embodiments 44-46, wherein the soluble oligomeric component is present in an amount less than an amount of the soluble oligomeric component that provides 1.5 SEV to the food or beverage product in the absence of the natural high-intensity sweetener, e.g., no more than ⅔ of amount, or no more than 113 of that amount, or no more than 1/10 of that amount, or no more than 1/15 of that amount.
   Embodiment 46. The method, composition or food or beverage product of any of embodiments 1-47, wherein the at least one sweetener comprises at least one bulk sweetener.
   Embodiment 49. The method, composition or food or beverage product of any of embodiments 1-47, wherein the at least one sweetener comprises at least one bulk sweetener selected from allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose, invert sugar, arabitol, glycerol, hydrogenated starch hydrolysate, isomalt, lactitol, maltitol, mannitol, sorbitol and xylitol; allulose (also known as D-psicose), glucose, erythritol, fructose, and sucrose.
   Embodiment 50. The method, composition or food or beverage product of any of embodiments 48 and 49 wherein the at least one bulk sweetener is present in the food or beverage in an amount such that it provides no more than 1.5 SEV to the food or beverage product, e.g., such that it provides no more than 1 SEV, or no more than 0.5 SEV to the food or beverage product (i.e., in the absence of the soluble oligomeric component).
   Embodiment 51. The method, composition or food or beverage product of any of embodiments 48 and 49 wherein the at least one bulk sweetener is present in the food or beverage in an amount such that it does not provide perceptible sweetness to the food or beverage product (i.e., in the absence of the soluble oligomeric component).
   Embodiment 52. The method, composition or food or beverage product of embodiment 50 or 51, wherein the sweetness enhancement is such that the at least one bulk sweetener and the soluble oligomeric component together provide at least 1.5 SEV to the food or beverage product, e.g., at least 2.0 SEV, at least 2.5 SEV, or even at least 3.0 SEV.
   Embodiment 53. The method, composition or food or beverage product of any of embodiments 50-52, wherein the soluble oligomeric component is present in an amount less than an amount of the soluble oligomeric component that provides 1.5 SEV to the food or beverage product in the absence of the bulk sweetener, e.g., no more than ⅔ of amount, or no more than ⅓ of that amount, or no more than 1/10 of that amount, or no more than 1/15 of that amount Embodiment 54. The method, composition or food or beverage product of any of embodiments 1-53, wherein the food or beverage product has a sweetness in the range of 1-20 SEV.
   Embodiment 55. The method, composition or food or beverage product of any of embodiments 1-53, wherein herein the food or beverage product has a sweetness in the range of 1-15 SEV, or 1-12 SEV, or 1-10 SEV, or 1-8 SEV, or 1-5 SEV, or 2-20 SEV, or 2-15 SEV, or 2-12 SEV, or 2-10 SEV, or 2-8 SEV, or 5-20 SEV, or 5-15 SEV, or 5-12 SEV, or 5-10 SEV, or 8-20 SEV, or 8-15 SEV, or 8-12 SEV, or 10-20 SEV, or 10-15 SEV, or 15-20 SEV.
   Embodiment 56. The method or food or beverage product of any of embodiments 1-55, wherein the perceived sweetness is an initial sweetness.
   Embodiment 57. The method or food or beverage product of any of embodiments 1-55, wherein the perceived sweetness is a maximum sweetness.
   Embodiment 58. A flavor modifying composition comprising at least 1 wt % of a soluble oligomeric component selected from soluble dietary fiber and polydextrose, or a combination thereof, in a food or beverage product, the soluble oligomeric component being present in an amount that alters (e.g., enhances or reduces) a perception of a flavor in the food or beverage product by an amount that is greater than any alteration due to a flavor of the soluble oligomeric component itself.
   Embodiment 59. A flavor-enhancing composition comprising at least 1 wt % of a soluble oligomeric component selected from soluble dietary fiber and polydextrose, or a combination thereof, in a food or beverage product, the soluble oligomeric component being present in an amount that enhances a perception of a flavor in the food or beverage product by an amount that is greater than any alteration due to a flavor of the soluble oligomeric component itself.
   Embodiment 60. A food or beverage product comprising at least 1 wt % of a soluble oligomeric component selected from soluble dietary fiber and polydextrose, or a combination thereof, wherein the soluble oligomeric component is present in an amount that alters (e.g., enhances or reduces) a perception of a flavor of the food or beverage product by an amount that is greater than any alteration due to a flavor of the soluble oligomeric component itself.
   Embodiment 61. A method for flavor modification, the method including: including at least 1 wt % of soluble oligomeric component selected from soluble dietary fiber and polydextrose, or a combination thereof in a food or beverage product, wherein the soluble oligomeric component alters (e.g., enhances or reduces) the perception of a flavor of the food or beverage product by an amount that is greater than any alteration due to a flavor of the soluble oligomeric component itself.
   Embodiment 62. A method for flavor enhancement, the method including: including at least 1 wt % of soluble oligomeric component selected from soluble dietary fiber and polydextrose, or a combination thereof in a food or beverage product, wherein the soluble oligomeric component enhances the perception of a flavor of the food or beverage product by an amount that is greater than any enhancement due to a flavor of the soluble oligomeric component itself.
   Embodiment 63. A method for altering (e.g., enhancing or reducing) the perception of a flavor of a food or beverage product, the method comprising including at least 1 wt % of soluble oligomeric component selected from soluble dietary fiber and polydextrose, or a combination thereof in the food or beverage product, wherein the soluble oligomeric component alters (e.g., enhances or reduces) the perception of a flavor of the food or beverage product by an amount that is greater than any alteration due to a flavor of the soluble oligomeric component itself.
   Embodiment 64. A method, composition or food or beverage product according to any of embodiments 58-63, wherein the alteration of the perception of the flavor is an enhancement of the perception of the flavor.
   Embodiment 65. A method, composition or food or beverage product according to embodiment 60, wherein the flavor is provided by a flavoring, and the enhancement provides a perception that is equivalent to a perception of the flavor in a food product lacking the soluble oligomeric component and including at least 120% of the amount of the flavoring, e.g., at least 150% of the amount of flavoring.
   Embodiment 66. A method, composition or food or beverage product according to any of embodiments 58-63, wherein the alteration of the perception of the flavor is a reduction of the perception of the flavor.
   Embodiment 67. A method, composition or food or beverage product according to embodiment 66, wherein the flavor is provided by a flavoring, and the reduction provides a perception that is equivalent to a perception of the flavor in a food product lacking the soluble oligomeric component and including no more than 83% of the amount of the flavoring, e.g., no more than 67% of the amount of flavoring.
   Embodiment 68. The method, composition or food product according to any of embodiments 58-67, wherein the soluble oligomeric component enhances a perception of a first flavor in the food or beverage product, and decreases a perception of a second flavor in the food or beverage product.
   Embodiment 69. The method, composition, or food or beverage product of any of embodiments 58-68, wherein the flavor is provided by a flavoring that is D-limonene, and the perception altered by the soluble oligomeric component is one or more of sweet, sour, lemon, peel, citrus, and astringency.
   Embodiment 70. The method, composition, or food or beverage product of any of embodiments 58-68, wherein the flavor is provided by a flavoring that is benzaldehyde, and the perception altered by the soluble oligomeric component is one or more of sour, sweetness, citrus, chemical off-flavor, bitter linger, corn-syrup off-note, and cardboard off-note.
   Embodiment 71. The method, composition, or food or beverage product of any of embodiments 58-68, wherein the flavor is provided by a flavoring that is ethyl butyrate, and the perception altered by the soluble oligomeric component is one or more of sweetness, sour, floral, grape level and grape flavor description.
   Embodiment 72. The method, composition, or food or beverage product of any of embodiments 58-71, wherein a perception is other than sweetness or similarity to sugar is altered.
   Embodiment 73. The method, composition, or food or beverage product of any of embodiments 58-72, wherein the food or beverage product includes a sweetener, e.g., in an amount to provide a SEV in the range of 1-20.
   Embodiment 74. The method, composition, or food or beverage product of any of embodiments 58-73, wherein the food or beverage product includes a sweetener as described in any of embodiments 1-49.
   Embodiment 75. The method, composition, or food or beverage product of any of embodiments 1-74, wherein the soluble oligomeric component is present in the food or beverage product in an amount of at least 2 wt %.
   Embodiment 76. The method, composition, or food or beverage product of any of embodiments 1-74, wherein the soluble oligomeric component is present in the food or beverage product in an amount of at least 3 wt %.
   Embodiment 77. The method, composition, or food or beverage product of any of embodiments 1-74, wherein the soluble oligomeric component is present in the food or beverage product in an amount of at least 5 wt %, e.g., at least 7 wt %.
   Embodiment 78. The method, composition, or food or beverage product of any of embodiments 1-74, wherein the soluble oligomeric component is present in the food or beverage product in an amount in the range of 1-15 wt %, e.g., 1-12 wt %, or 1-10 wt %, or 1-8 wt %.
   Embodiment 79. The method, composition, or food or beverage product of any of embodiments 1-74, wherein the soluble oligomeric component is present in the food or beverage product in an amount in the range of 2-15 wt %, e.g., 2-12 wt %, or 2-10 wt %, or 2-8 wt %.
   Embodiment 80. The method, composition, or food or beverage product of any of embodiments 1-74, wherein the soluble oligomeric component is present in the food or beverage product in an amount in the range of 3-15 wt %, e.g., 3-11 wt %, or 3-10 wt %, or 3-8 wt %.
   Embodiment 81. The method, composition, or food or beverage product of any of embodiments 1-74, wherein the soluble oligomeric component is present in the food or beverage product in an amount in the range of 5-15 VA %, e.g., 5-12 wt %, or 5-10 wt %, or 5-8 wt %.
   Embodiment 32. The method, composition, or food or beverage product of any of embodiments 1-74, wherein the soluble oligomeric component is present in the food or beverage product in an amount in the range of 7-15 wt %, e.g., 7-12 wt %, or 7-10 wt %.
   Embodiment 83. The method, composition, or food or beverage product of any of embodiments 1-82, wherein the soluble oligomeric component is a soluble dietary fiber.
   Embodiment 84. The method, composition, or food or beverage product of embodiment 83, wherein the soluble dietary fiber has a weight-average molecular weight in the range of 1000 g/mol to 2500 g/mol.
   Embodiment 85. The method, composition, or food or beverage product of embodiment 83, wherein the soluble dietary fiber has a weight-average molecular weight in the range of 1000 g/mol to 2000 g/mol.
   Embodiment 86. The method, composition, or food or beverage product of embodiment 83, wherein the soluble dietary fiber has a weight-average molecular weight in the range of 1000 to 2250 g/mol, or 1000 g/mol to 1800 g/mol, or 1000 g/mol to 1600 g/mol, or 1200 to 2500 g/mol, or 1200 to 2250 g/mol, or 1200 g/mol to 2000 g/mol, or 1200 g/mol to 1800 g/mol, or 1200 g/mol to 1600 g/mol, or 1400 to 2500 g/mol, or 1400 to 2250 g/mol, or 1400 g/mol to 2000 g/mol, or 1400 g/mol to 1800 g/mol, or 1600 to 2500 g/mol, or 1600 to 2250 g/mol, or 1600 g/mol to 2000 g/mol, or 1800 g/mol to 2500 g/mol, or 1800 to 2250 g/mol, or 2000 g/mol to 2500 g/mol.
   Embodiment 87. The method, composition, or food or beverage product of any of embodiments 83-86, wherein the soluble dietary fiber has a total amount of mono- and disaccharides up to 25 wt % on a dry solids basis, e.g., up to 20 wt %.
   Embodiment 88. The method, composition, or food or beverage product of any of embodiments 83-86, wherein the soluble dietary fiber has a total amount of mono- and disaccharides up to 15 wt % on a dry solids basis, e.g., up to 10 wt %.
   Embodiment 89. The method, composition, or food or beverage product of any of embodiments 83-86, wherein the soluble dietary fiber has a total amount of mono- and disaccharides no more than 5 wt % on a dry solids basis, e.g., no more than 3 wt %.
   Embodiment 90. The method, composition, or food or beverage product of any of embodiments 83-86, wherein the soluble dietary fiber has a total amount of mono- and disaccharides no more than 2 wt % on a dry solids basis, e.g., no more than 1 wt %.
   Embodiment 91. The method, composition, or food or beverage product of any of embodiments 83-86, wherein the soluble dietary fiber has a total amount of mono- and disaccharides in the range of 3-20%.
   Embodiment 92. The method, composition, or food or beverage product of any of embodiments 83-91, wherein the soluble dietary fiber has a linkage pattern comprising:
25-45% terminally-linked glucopyranosyl residues;
10-22% 6-linked glucopyranosyl residues;
13-32% 4-linked glucopyranosyl residues;
2-11% 3-linked glucopyranosyl residues;
3-13% 4,6-linked glucopyranosyl residues;
1-5% 3,6-linked glucopyranosyl residues;
0.5-4% 2,4-linked glucopyranosyl residues.
   Embodiment 93. The method, composition, or food or beverage product of any of embodiments 83-91, wherein the soluble dietary fiber has a linkage pattern comprising:
29-45% terminally-linked glucopyranosyl residues;
10-22% 6-linked glucopyranosyl residues;
13-27% 4-linked glucopyranosyl residues;
2-11% 3-linked glucopyranosyl residues;
3-13% 4,6-linked glucopyranosyl residues;
1-5% 3,6-linked glucopyranosyl residues;
0.5-4% 2,4-linked glucopyranosyl residues.
   Embodiment 94. The method, composition, or food or beverage product of any of embodiments 83-93, wherein the soluble dietary fiber has a fiber content of at least 65%.
   Embodiment 95. The method, composition, or food or beverage product of any of embodiments 83-93, wherein the soluble dietary fiber has a fiber content of at least 70%.
   Embodiment 96. The method, composition, or food or beverage product of any of embodiments 83-93, wherein the soluble dietary fiber has a fiber content in the range of 70% to 95%, e.g., in the range of 70% to 90%, or 70% to 85%, or 70% to 80%.
   Embodiment 97. The method, composition, or food or beverage product of any of embodiments 83-93, wherein the soluble dietary fiber has a fiber content in the range of 65% to 85%, e.g., in the range of 65% to 80%, or in the range of 65% to 75%.
   Embodiment 98. The method, composition, or food or beverage product of any of embodiments 83-97, wherein the soluble dietary fiber is made by a process comprising:
providing a saccharide feed comprising at least 95 wt % (e.g., at least 97 wt %, at least 98 wt % or at least 99 wt %) on a dry solids basis of dextrose and/or dextrose oligomers;
reacting the saccharide feed in the presence of water and in the substantial absence of sugar alcohols at a total solids concentration of at least about 80% by weight and a temperature of at least about 120° C. with at least one acid catalyst that accelerates the rate of cleavage and formation of glucosyl bonds for a time sufficient to produce a product composition having a fiber content of at least 60% fiber.
   Embodiment 99. The method, composition, or food or beverage product of embodiment 98, wherein the saccharide feed is a starch hydrolysate or dextrose.
   Embodiment 100. The method, composition, or food or beverage product of any of embodiments 1-82, wherein the soluble oligomeric component is a polydextrose.
   Embodiment 101. The method, composition, or food or beverage product of any of embodiments 1-100, wherein the food or beverage product is a dairy product, or a dairy alternative, e.g., selected from yogurt, yogurt drinks, fermented dairy beverages, quarks, milk drinks, flavored milks, smoothies, ice cream, shakes, cottage cheese, sour creams, crèmes fraiches, cottage cheese dressing, and dairy desserts, such as quarg and the whipped mousse-type products.
   Embodiment 102. The method, composition, or food or beverage product of any of embodiments 1-100, wherein the food or beverage product is a beverage, e.g., a sweetened beverage.
   Embodiment 103. The method, composition, or food or beverage product of any of embodiments 1-100, wherein the food or beverage product is a tea drink, a coffee drink, a soda, a flavored water, a punch, an ade, or a juice.
   Embodiment 104. The method, composition, or food or beverage product of any of embodiments 1-100, wherein the food or beverage product is an alcoholic beverage such as beer, wine, a cocktail, a cooler or a hard seltzer.
   Embodiment 105. The method, composition, or food or beverage product of any of embodiments 1-100, wherein the food or beverage product is a cereal, a granola, a muesli, a topping, a coating, a confectionery coating, a baked good (e.g., cookie, a biscuit, a bread, a pastry, a pizza crust, a flatbread), a bar (e.g., snack bar, cereal bar, granola bar, energy bar), a meat alternative, a filling (e.g., a fruit filling or a crème filling), a fruit snack such as a fruit leather, a pasta, a sweetener, a frozen dessert, a dairy product, a dairy alternative (e.g., a yogurt, a quark, an ice cream), a glaze, a frosting, a beverage, a syrup, a pet food, a medical food, a flavoring, or a dry blend.
   Embodiment 106. The method, composition, or food or beverage product of any of embodiments 1-100, wherein the food or beverage product is a confection.
   Embodiment 107. The method, composition, or food or beverage product of any of embodiments 1-100, wherein the food or beverage product is a spread (e.g., a nut butter).
   Embodiment 108. The method, composition or food or beverage product of any of embodiments 1-100, wherein the food or beverage product is a chocolate confectionary.
   Embodiment 109. The method, composition or food or beverage product of any of embodiments 1-108, wherein the food or beverage product is provided as a dry mix.

What is claimed is:

1. A sweet-taste enhancing composition comprising
at least one sweetener; and
at least 1 wt % of a soluble oligomeric component selected from soluble dietary fiber and polydextrose, or a combination thereof,
in a food or beverage product,
wherein the soluble oligomeric component is present in an amount that enhances the perceived sweet taste of the sweetened food or beverage product by an amount that is greater than a sweet taste due to the soluble oligomeric component itself.

2. A sweetness-enhancing composition comprising
at least one sweetener; and
at least 1 wt % of a soluble oligomeric component selected from soluble dietary fiber and polydextrose, or a combination thereof,
in a food or beverage product,
wherein the soluble oligomeric component is present in an amount that enhances the perceived sweetness of the sweetened food or beverage product by an amount that is greater than a sweetness due to the soluble oligomeric component itself.

3. A flavor-modifying composition comprising
at least one sweetener; and
at least 1 wt % of a soluble oligomeric component selected from soluble dietary fiber and polydextrose, or a combination thereof,
in a food or beverage product,
wherein the soluble oligomeric component is present in an amount that alters (e.g., enhances or reduces) a flavor of the food or beverage product by an amount that is greater than any alteration due to a flavor of the soluble oligomeric component itself.

4. A flavor-enhancing composition comprising
at least one sweetener; and
at least 1 wt % of a soluble oligomeric component selected from soluble dietary fiber and polydextrose, or a combination thereof,
in a food or beverage product,
wherein the soluble oligomeric component is present in an amount that enhances a flavor of the food or beverage product by an amount that is greater than any alteration due to a flavor of the soluble oligomeric component itself.

5. A sweetened food or beverage product comprising
at least one sweetener; and
at least 1 wt % of a soluble oligomeric component selected from soluble dietary fiber and polydextrose, or a combination thereof,
wherein the soluble oligomeric component is present in an amount that enhances the perceived sweetness of the sweetened food or beverage product by an amount that is greater than a sweetness due to the soluble oligomeric component itself.

6. A method for enhancing the sweetness of a food or beverage product containing at least one sweetener, the method comprising including at least 1 wt % of soluble oligomeric component selected from soluble dietary fiber and polydextrose, or a combination thereof in the food or beverage product, the enhancement being by an amount that is greater than a sweetness due to the soluble oligomeric component itself.

7. A method of sweet taste enhancement, the method comprising including in a food or beverage containing at least one sweetener at least 1 wt % of soluble oligomeric component selected from soluble dietary fiber and polydextrose, or a combination thereof, the enhancement being by an amount that is greater than a sweet taste due to the soluble oligomeric component itself.

8. A method of sweetness enhancement, the method comprising including in a food or beverage containing at least one sweetener at least 1 wt % of soluble oligomeric component selected from soluble dietary fiber and polydextrose, or a combination thereof, the enhancement being by an amount that is greater than a sweetness due to the soluble oligomeric component itself.

9. A method of flavor modification, the method comprising including in a food or beverage containing at least one sweetener at least 1 wt % of soluble oligomeric component selected from soluble dietary fiber and polydextrose, or a combination thereof, the soluble oligomeric component being included in an amount that alters (e.g., enhances or reduces) a flavor of the food or beverage product by an amount that is greater than any alteration due to a flavor of the soluble oligomeric component itself.

10. A method of flavor enhancement, the method comprising including in a food or beverage containing at least one sweetener at least 1 wt % of soluble oligomeric component selected from soluble dietary fiber and polydextrose, or a combination thereof, the soluble oligomeric component being included in an amount that enhances a flavor of the food or beverage product by an amount that is greater than any alteration due to a flavor of the soluble oligomeric component itself.

11. The method, composition or food or beverage product of any of claims 1-10, wherein the soluble oligomeric component does not provide substantial sweetness (e.g., no more than 0.1 SEV).

12. The method, composition or food or beverage product of any of claims 1-10, wherein the enhancement in sweetness is at least 1.5 SEV, e.g., in the range of 1.5-3.5 SEV, or 1.5-3 SEV.

13. The method, composition or food or beverage product of any of claims 1-10, wherein the at least one sweetener is at least one steviol glycoside.

14. The method, composition or food or beverage product of claim 13, wherein the at least one steviol glycoside is present in the food or beverage product in an amount less than an amount that provides 1.5 SEV to the food or beverage product, e.g., no more than 213, or no more than ⅓ of the amount that provides 1.5 SEV to the food or beverage product (i.e., in the absence of the soluble oligomeric component).

15. The method, composition or food or beverage product of claim 13, wherein the at least one steviol glycoside is present in the food or beverage in an amount such that it does not provide perceptible sweetness to the food or beverage product (i.e., in the absence of the soluble oligomeric component).

16. The method, composition or food or beverage product of claim 14 wherein the sweetness enhancement is such that the steviol glycoside and soluble oligomeric component together provide at least 1.5 SEV to the food or beverage product, e.g., at least 2.0 SEV, at least 2.5 SEV, or even at least 3.0 SEV.

17. The method, composition or food or beverage product of claim 16, wherein the soluble oligomeric component is present in an amount less than an amount of the soluble oligomeric component that provides 1.5 SEV to the food or beverage product in the absence of the steviol glycoside, e.g., no more than 213 of amount, or no more than ⅓ of that amount, or no more than 1/10 of that amount, or no more than 1/15 of that amount.

18. The method, composition or food or beverage product of claim 13, wherein the food or beverage product does not include a sweetening sugar selected from sucrose, fructose, dextrose and xylose in an amount that provides more than 1 SEV, e.g., more than 0.5 SEV or more than 0.2 SEV, to the food or beverage product.

19. The method, composition or food or beverage product of any of claims 1-10, wherein the at least one sweetener comprises at least one high-intensity sweetener.

20. The method, composition or food or beverage product of any of claims 1-10, wherein the food or beverage product has a sweetness in the range of 2-20 SEV.

21. A flavor modifying composition comprising at least 1 wt % of a soluble oligomeric component selected from soluble dietary fiber and polydextrose, or a combination thereof, in a food or beverage product, the soluble oligomeric component being present in an amount that alters (e.g., enhances or reduces) a perception of a flavor in the food or beverage product by an amount that is greater than any alteration due to a flavor of the soluble oligomeric component itself.

22. A food or beverage product comprising at least 1 wt % of a soluble oligomeric component selected from soluble dietary fiber and polydextrose, or a combination thereof, wherein the soluble oligomeric component is present in an amount that alters (e.g., enhances or reduces) a perception of a flavor of the food or beverage product by an amount that is greater than any alteration due to a flavor of the soluble oligomeric component itself.

23. A method, composition or food or beverage product according to claim 21 or claim 22, wherein the alteration of the perception of the flavor is an enhancement of the perception of the flavor, wherein the flavor is provided by a flavoring, and the enhancement provides a perception that is equivalent to a perception of the flavor in a food product lacking the soluble oligomeric component and including at least 120% of the amount of the flavoring, e.g., at least 150% of the amount of flavoring.

24. The method, composition, or food or beverage product of any of claims 1-10, 21 and 22, wherein the soluble oligomeric component is present in the food or beverage product in an amount of at least 2 wt %.

25. The method, composition, or food or beverage product of any of claims 1-10, 21 and 22, wherein the soluble oligomeric component is present in the food or beverage product in an amount of at least 5 wt %, e.g., at least 7 wt %.

26. The method, composition, or food or beverage product of any of claims 1-10, 21 and 22, wherein the soluble oligomeric component is a soluble dietary fiber.

27. The method, composition, or food or beverage product of claim 26, wherein the soluble dietary fiber has a weight-average molecular weight in the range of 1000 g/mol to 2500 g/mol.

28. The method, composition, or food or beverage product of claim 27, wherein the soluble dietary fiber has a linkage pattern comprising:
25-45% terminally-linked glucopyranosyl residues;
10-22% 6-linked glucopyranosyl residues;
13-32% 4-linked glucopyranosyl residues;
2-11% 3-linked glucopyranosyl residues;
3-13% 4,6-linked glucopyranosyl residues;
1-5% 3,6-linked glucopyranosyl residues;
0.5-4% 2,4-linked glucopyranosyl residues.

29. The method, composition, or food or beverage product of claim 27, wherein the soluble dietary fiber has a fiber content of at least 70%.

30. The method, composition, or food or beverage product of claim 29, wherein the soluble dietary fiber is made by a process comprising:
providing a saccharide feed comprising at least 95 wt % (e.g., at least 97 wt %, at least 98 wt % or at least 99 wt %) on a dry solids basis of dextrose and/or dextrose oligomers;
reacting the saccharide feed in the presence of water and in the substantial absence of sugar alcohols at a total solids concentration of at least about 80% by weight and a temperature of at least about 120° C. with at least one acid catalyst that accelerates the rate of cleavage and formation of glucosyl bonds for a time sufficient to produce a product composition having a fiber content of at least 60% fiber.

31. The method, composition, or food or beverage product of any of claims 1-10, 21 and 22, wherein the food or beverage product is
a dairy product, or a dairy alternative, e.g., selected from yogurt, yogurt drinks, fermented dairy beverages, quarks, milk drinks, flavored milks, smoothies, ice cream, shakes, cottage cheese, sour creams, crèmes fraiches, cottage cheese dressing, and dairy desserts, such as quarg and the whipped mousse-type products;
a beverage, e.g., a sweetened beverage, or a tea drink, a coffee drink, a soda, a flavored water, a punch, an ade, or a juice, or an alcoholic beverage such as beer, wine, a cocktail, a cooler or a hard seltzer;
a cereal, a granola, a muesli, a topping, a coating, a confectionery coating, a baked good (e.g., cookie, a biscuit, a bread, a pastry, a pizza crust, a flatbread), a bar (e.g., snack bar, cereal bar, granola bar, energy bar), a meat alternative, a filling (e.g., a fruit filling or a crème filling), a fruit snack such as a fruit leather, a pasta, a sweetener, a frozen dessert, a dairy product, a dairy alternative (e.g., a yogurt, a quark, an ice cream), a glaze, a frosting, a beverage, a syrup, a pet food, a medical food, a flavoring, or a dry blend;
a confection such as a chocolate confection; or
a spread (e.g., a nut butter).
